(19) United States
(12) Patent Application Publication
(10) Pub. No.: US 2025/0381561 A1
(43) Pub. Date: Dec. 18, 2025

(54) SORBENT WITH GAS-PERMEABLE AND HYDROPHOBIC MEMBRANE

(71) Applicant: University of Pittsburgh - Of the Commonwealth System of Higher Education, Pittsburgh, PA (US)

(72) Inventors: Evan D. Richards, Pittsburgh, PA (US); Sang-Ho Ye, Pittsburgh, PA (US); Lei Li, Wexford, PA (US)

(21) Appl. No.: 18/876,310

(22) PCT Filed: Jun. 28, 2023
(86) PCT No.: PCT/US2023/069280

§ 371 Date: Dec. 18, 2024

Related U.S. Application Data
(60) Provisional application No. 63/356,662, filed on Jun. 29, 2022.
(60) Provisional application No. 63/440,644, filed on Jan. 23, 2023.

(51) Int. Cl. B01J 39/12; B01J 47/12

(52) U.S. Cl. CPC B01J 39/12; B01J 47/12

(57) ABSTRACT

A composition includes a solid particle including a sorbent material and a gas permeable and hydrophobic coating formed over the solid particle. The gas permeable and hydrophobic coating: is formed via a coating technique in which one or more layers of one or more hydrophobic polymers is formed over a surface of the solid particle while substantially preserving absorption capacity of the sorbent material.

### CROSS-REFERENCE TO RELATED APPLICATION

This application claims benefit of U.S. Provisional Patent Application Ser. No. 63/356,662, filed Jun. 29, 2022 and U.S. Provisional Patent Application Ser. No. 63/440,644, filed Jan. 23, 2023, the disclosures of which are incorporated herein by reference.

### BACKGROUND

The following information is provided to assist the reader in understanding the technologies disclosed below and the environment in which such technologies may be used. The terms used herein are not intended to be limited to any particular narrow interpretation unless clearly stated otherwise in this document. References set forth herein may facilitate understanding of the technologies or the background thereof. The disclosure of all references cited herein are incorporated by reference.

Chronic Kidney Disease (CKD) affects 8-16% of the global population and 15% of the United States population. Approximately 726,000 adults in the United States are receiving dialysis for kidney failure or living with a kidney transplant. End-Stage Kidney Disease (ESKD) is defined as the final stage of CKD based on the National Kidney Foundation Kidney Disease Outcomes Quality Initiative classification system. An estimated 125,000 Americans start dialysis treatment every year for ESKD. A 2019 study shows ESKD patients on dialysis have a 5 and 10-year survival rate of 51% and 30%, respectively. Key contributors to ESKD illness are nitrogen-containing uremic toxins. Urea is not toxic, but the resulting nitrogen compounds are. A high urea level may limit formation of area by the liver and increase the generation of nitrogen-containing toxins.

Kidney transplantation is the optimal method to treat ESKD. But the wait-list for a kidney often exceeds 3.5-years. Over 85% of ESKD patients are treated via in-center hemodialysis three times a week for up to four hours every treatment. Such infrequent treatment results in uremic toxin accumulation and excessive water and salt build-up. Water and salt excess causes conditions such as hypertension, heart failure, and pulmonary edema. Peritoneal dialysis aims to mitigate the time-requirement by allowing patients to perform dialysis away from the clinic, and on a more continuous schedule. But overall toxin removal is less efficient for peritoneal dialysis than for hemodialysis. Higher toxin levels, mechanical issues, and infections associated with peritoneal dialysis ultimately result in many patients changing from peritoneal dialysis to hemodialysis. The quality of life for patients receiving hemodialysis or peritoneal dialysis is poor as a result of high treatment burden, increased risk of infections, and dietary restrictions. An improved ESKD treatment process could benefit both the patient and clinician.

Numerous research groups have tried to make dialysis therapy more practical by using sorbents to bind uremic toxins. A number of research groups have, for example, targeted the improvement of an ESKD patient's quality of life by making dialysis therapy more practical and home-based. Proposed treatment methods range from oral sorbents for lowering toxins between dialysis treatments to columns packed with sorbent material capable of regenerating dialysate. Phosphate and potassium ions are removed by ion exchangers in these columns. Organic impurities are removed by carbon. Urea's low affinity for available sorbents and high molar production rate (240-mmol area/day) have made it the most difficult waste-product to eliminate from dialysate.

Enzymatic hydrolysis of urea with urease followed by ammonium capture has shown promise and resulted in a portable artificial kidney named “REDY sorbent system” used from 1973 to 1994. More than 6-million patient treatments were achieved with the system, demonstrating its safety and clinical feasibility as a dialysate regeneration system. In such systems, urea was hydrolyzed by urease to form NH₄⁺. NH₄⁺ was then removed by the cation exchanger ZrP. Cation exchange refers to an electrochemical process in which identical cation charges are equally exchanged between a solution like water and a solid material. ZrP is a non-selective cation exchanger. ZrP has a higher affinity for divalent cations than monovalent cations. The exchanger's non-selective property in the presence of other ions, however, limits its binding capacity to approximately 0.95-mEq NH₄⁺/g-ZrP. Up to 1-kg of ZrP was used within the REDY sorbent column because of its low affinity for NH₄⁺. ZrP's non-selectivity lowers Ca²⁺, Mg²⁺, and K⁺ levels in the dialysate. These ions are replenished by infusing them back into the dialysate. Several research groups are now working to develop newer versions of the REDY sorbent column for highly portable dialysis treatments. Most of these technologies focus on binding ammonium via ZrP as a result of that material's proven safety and higher binding capacity. However, chemical complexity, bicarbonate, Ca²⁺, Mg²⁺, Na⁺, and K⁺ complicate the process and add more mass to a portable device with a sorbent column containing urease and cation exchangers.

At least one study has shown the viability of using a gas-permeable liquid membrane to create an NH₄⁺ trap with citric acid enclosed in mineral oil. However, the membrane was not stable.

It remains desirable to develop improved systems, devices, methods, and compositions to remove urea in treatment therapies of kidney disease. Moreover, it is desirable to develop sorbents generally for selective removal of various gases from aqueous environments.

### SUMMARY

In one aspect, a composition includes a solid substrate such as a solid particle including a sorbent material and a gas-permeable and hydrophobic coating formed over the solid substrate/solid particle. The gas permeable and hydrophobic coating is formed via a coating technique in which one or more layers of one or more hydrophobic polymers is formed over a surface of the solid substrate/solid particle while substantially preserving absorption capacity of the sorbent material. In a number of embodiments, the gas-permeable and hydrophobic coating is formed by spray coating a solution of the one or more hydrophobic polymer or by covalently attaching the one or more hydrophobic polymers to the surface of the solid particle via functional groups on the surface of the solid particle.

The gas-permeable and hydrophobic coatings hereof may, for example, improve selectivity for a target gas in an aqueous environment including ionic species that can compete for absorption capacity. Without limitation to any mechanism, reduction in concentration of the target gas (via, for example, absorption or any other mechanism) is improved in the compositions hereof as compared to use of uncoated solid particles or other uncoated solid substrates which include a sorbent material. In a number of embodiments hereof, the target gas species may, for example, be any species that is present as a gas in an aqueous environment and that may be converted to ions in the vicinity of the solid substrate of the coated compositions hereof.

In a number of embodiments, the sorbent material is an ion exchange material. The composition may further include a component to convert a gas passing through the gas-permeable and hydrophobic coating to an ion. The sorbent material may be a cation exchange material or an anion exchange material.

The one or more hydrophobic polymers may, for example, include a polysiloxane, a fluoropolymer, an acrylate, a polyurethane acrylate, a polyacetylene, an addition-type polynorbornene, a polymer of intrinsic microporosity (PIM), a low-density polyethylene, or a polyimide. In a number of embodiments, the one or more hydrophobic polymers include a polysiloxane or a fluoropolymer (for example, a polyfluorinated polymer or a perfluoropolymer). In a number of embodiments, the hydrophobic polymer is selected to have chemical stability (for example, acid resistance). For example, the hydrophobic polymer may include a chemically resistant fluoropolymer (for example, a perfluoropolymer). In a number of embodiments, an acid-resistant hydrophobic polymer hereof exhibits resistance to acidic pH levels such as the pH levels of the stomach, which vary between 1 and 5, and most commonly between 1.5 and 2. Such a polymer may exhibit resistance to such pH levels for a residence time of up to 3 hours.

The solid particle may, for example, have an average diameter in the range of 10 nm to 10 mm. In a number of embodiments, the solid particle includes a cation exchange material and is a solid particle comprising zirconium phosphate (ZrP), sodium zirconium cyclosilicate, or a resin-based cation exchange material, or a metal oxide. The metal oxide may, for example, be SiO₂ or TiO₂

In a number of embodiments, the one or more hydrophobic polymers are covalently attached to the surface of the solid particle including the sorbent material via a multifunctional compound which is reacted with one or more functional groups on the surface of the solid particle including the sorbent material and reacted with one or more functional groups on the one or more hydrophobic polymers. The multifunctional compound in a number of embodiments has suitable functionality to increase the number of sites with which the hydrophobic polymer can covalently react after the multifunctional compound is reacted with the one or more functional group on the surface of solid particle.

In a number of embodiments, at least one of the one or more hydrophobic polymers is a polysiloxane or a fluoropolymer and the multifunctional compound is tetraethyl orthosilicate or a compound including one or more trialkoxysilane groups. In a number of embodiments, the sorbent material is or include a cation exchange material. In a number of embodiments, the solid particle including the cation exchange material includes zirconium phosphate. In embodiments in which the solid particle includes a cation exchange material, the cation exchange material may be hydrogen loaded to convert a gas passing through the gas-permeable and hydrophobic coating to a cation.

In a number of embodiments, the gas-permeable and hydrophobic coating is formed via spray coating of the surface of the solid particle.

In another aspect, a method of selectively removing a gas from an aqueous environment, includes contacting the aqueous environment with a plurality of the compositions. Each of the compositions comprises a solid substrate such as a solid particle including a sorbent material and a gas-permeable and hydrophobic coating formed over the solid substrate/solid particle. The gas permeable and hydrophobic coating is formed via a coating technique in which one or more layers of one or more hydrophobic polymers is formed over a surface of the solid substrate/solid particle while substantially preserving absorption capacity of the sorbent material. The sorbent material is an ion exchange material. The ion exchange material may be a cation exchange material or an anion exchange material. each of the compositions may further include a component or chemical species to convert a gas passing through the gas-permeable and hydrophobic coating to an ion.

In a number of embodiments, the one or more hydrophobic polymers include a polysiloxane, a fluoropolymer, an acrylate, a polyurethane acrylate, a polyacetylene, an addition-type polynorbornene, a polymer of intrinsic microporosity (PIM), a low-density polyethylene, or a polyimide.

The solid particle may have an average diameter in the range of 10 nm to 10 mm. In a number of embodiments in which the solid particle includes a cation exchange material, the solid particle includes zirconium phosphate, sodium zirconium cyclosilicate, or a resin-based cation exchange material, or a metal oxide. The metal oxide may, for example, be SiO₂ or TiO₂.

In a number of embodiments, the one or more hydrophobic polymers are covalently attached to the surface of the solid particle including the sorbent material via a multifunctional compound which is reacted with one or more functional groups on the surface of the solid particle including the sorbent material and reacted with one or more functional groups on the one or more hydrophobic polymers. The multifunctional compound may have suitable functionality to increase the number of sites with which the one or more hydrophobic polymers can covalently react after the multifunctional compound is reacted with the one or more functional group on the surface of solid particle. In a number of embodiments, the at least one of the one or more hydrophobic polymers is a polysiloxane or a fluoropolymer and the multifunctional compound is tetraethyl orthosilicate or a compound including one or more trialkoxysilane groups. In a number of such embodiments, the sorbent material is a cation exchange material and the solid particle comprising the cation exchange material comprises zirconium phosphate.

A cation exchange material hereof may be hydrogen loaded to convert a gas passing through the gas-permeable and hydrophobic coating to a cation.

In a number of embodiments, the gas-permeable and hydrophobic coating is formed via spray coating of the surface of the solid particle.

The aqueous environment may, for example, include ions other than an ion formed from the gas that can bind to the ion exchange material. In a number of embodiments, the gas is ammonia, the sorbent material is a hydrogen-loaded cation exchange material, and the aqueous environment includes cations other than ammonium.

In another aspect, a method of removing ammonia from an aqueous environment includes contacting the aqueous environment with a plurality of the compositions. Each of the compositions includes a solid substrate such as a solid particle including a cation exchange material and a gas-permeable and hydrophobic coating formed over the solid particle. The gas permeable and hydrophobic coating is formed via a coating technique in which one or more layers of one or more hydrophobic polymers is formed over a surface of the solid substrate/solid particle while substantially preserving absorption capacity of the sorbent material. In a number of embodiments, the cation exchange material includes zirconium phosphate. The cation exchange material may be hydrogen loaded to convert ammonia gas passing through the gas-permeable and hydrophobic coating to a cation. In a number of embodiments, the one or more hydrophobic polymers include a polysiloxane, a fluoropolymer, an acrylate, a polyurethane acrylate, a polyacetylene, an addition-type polynorborene, a polymer of intrinsic microporosity (PIM), a low-density polyethylene, or a polyimide. In a number of embodiments, the one or more hydrophobic polymers include a polysiloxane or a fluoropolymer. The fluoropolymer may, for example, be a perflouropolymer.

In another aspect, method of forming a composition includes forming a gas-permeable and hydrophobic coating comprising one or more hydrophobic polymers on a solid substrate such as a solid particle including a sorbent material using a coating technique that substantially preserves absorption capacity of the sorbent material. The gas permeable and hydrophobic coating may, for example, be formed by spray coating a solution of the one or more hydrophobic polymers or by covalently attaching the one or more hydrophobic polymers to a surface of the solid substrate/solid particle including the sorbent material via functional groups on the surface of the solid substrate/solid particle comprising the sorbent material or the coating is formed by a spray coating technique. As described above the sorbent material is an ion exchange material (a cation exchange material or an anion exchange material). In a number of embodiments, the sorbent material is a cation exchange material. The one or more hydrophobic polymers may, for example, include a polysiloxane, a fluoropolymer, an acrylate, a polyurethane acrylate, a polyacetylene, an addition-type polynorbornene, a polymer of intrinsic microporosity (PIM), a low-density polyethylene, or a polyimide. The solid particle including the sorbent material may have a diameter in the range of 10 nm to 10 mm. In a number of embodiments, the solid particle includes zirconium phosphate, sodium zirconium cyclosilicate, a metal oxide, or a resin-based cation exchange material. The metal oxide may, for example, be SiO₂ or TiO₂.

In a number of embodiments, the one or more hydrophobic polymers are covalently attached to the surface of the solid particle including the sorbent material via a multifunctional compound which is reacted with one or more functional groups on the surface of the solid particle including the sorbent material and reacted with one or more functional groups on the one or more hydrophobic polymers. The multifunctional compound may, for example, have suitable functionality to increase the number of sites with which the one or more hydrophobic polymers can covalently react after the multifunctional compound is reacted with the one or more functional groups on the surface of solid particle. In a number of embodiments, the one or more hydrophobic polymers include a polysiloxane or a fluoropolymer and the multifunctional compound is tetraethyl orthosilicate or a compound including one or more trialkoxysilane groups. In a number of such embodiments, the sorbent material is a cation exchange material and the solid particle of the cation exchange material is a solid particle of zirconium phosphate. The cation exchange material may be hydrogen loaded.

In another aspect, a composition, includes a solid substrate including a sorbent material and a gas-permeable and hydrophobic coating on the solid substrate. The gas-permeable and hydrophobic coating includes one or more hydrophobic polymers and is formed using a coating technique that substantially preserves absorption capacity of the sorbent material. The gas-permeable and hydrophobic coating may, for example, be formed by spray coating the one or more hydrophobic polymers or by covalently attaching the one or more hydrophobic polymers to a surface of the solid substrate via functional groups on the surface of the solid substrate or by spray coating one or more hydrophobic polymers on the surface of the solid substrate. In a number of embodiments, the sorbent material is an ion exchange material (a cation exchange material or an anion exchange material.

In a further aspect, a method of removing a gas from an aqueous environment includes contacting the aqueous environment with the composition hereof. In a number of embodiments, the sorbent material is an ion exchange material and the aqueous environment includes ions other than an ion formed from the gas that can bind to the ion exchange material. In a number of embodiments, the gas is ammonia, the sorbent material is a hydrogen-loaded cation exchange material, and the aqueous environment includes cations other than ammonium.

In still a further aspect, a method of forming a composition includes forming a gas-permeable and hydrophobic coating on a solid substrate including a sorbent material using a coating technique that substantially preserves absorption capacity of the sorbent material. In a number of embodiments, the gas permeable and hydrophobic coating is formed by spray coating one or more hydrophobic polymers or by covalently attaching one or more hydrophobic polymers to a surface of the solid substrate via functional groups on the surface of the solid substrate including the sorbent material or by spray coating one or more hydrophobic polymers on the surface of the solid substrate. The sorbent material may be an ion exchange material (a cation exchange material or an anion exchange material).

The present devices, systems, methods, and compositions along with the attributes and attendant advantages thereof, will best be appreciated and understood in view of the following detailed description taken in conjunction with the accompanying drawings.

### BRIEF DESCRIPTION OF THE DRAWINGS

FIG. 1 illustrates atomic composition analysis to compare membrane development on the surface of ZrP using a ZrP-TP₂ PDMS-coating protocol in panel (a), wherein hydrogen loaded ZrP was first coated with activated TEOS to form a polysiloxane membrane on the surface, which was then coated with activated PDMS, and a ZrP-P₂ PDMS-coating protocol in panel (b) hydrogen loaded ZrP was coated with activated PDMS.

FIG. 2 illustrates scanning electron microscopy (SEM) images of uncoated ZrP versus ZrP-TP₂, wherein the images captured the heterogeneity of both materials at 100× magnification, and 10,000× and 20,000× magnifications identified the porous nature of uncoated ZrP and a visible polydimethylsiloxane (PDMS) coating present on ZrP-TP₂.

FIG. 3 illustrates water contact angle (WCA) analysis of uncoated ZrP (left) and ZrP-TP₂ (right), wherein 2-uL droplet of DI water was placed on the surface of a flattened, 1-mm thick bed of material, testing was performed in triplicate and two angles were determined for each test (n=6).

FIG. 4 illustrates a binding study of uncoated ZrP Ca²⁺, which was used to determine the total amount of Ca²⁺ in simulated small intestine.

FIG. 5 illustrates a simulated small bowel solution study which compared the binding rate of NH⁴⁺ and selectivity in the presence of Ca²⁺ for ZrP-TP₂, ZrP-P₂, and uncoated or naked ZrP, wherein [NH₄⁺]=14-mM and [Ca²⁺]=12-mM. NH₄⁺ and Ca²⁺ binding of panels (a) and (b), respectively, was studied over a 5-hour time-course.

FIG. 6 illustrates atomic surface composition determined by XPS indicating surface composition of ZrP and ZrP-T, and membrane coatings on ZrP-FOTS_{1%}, ZrP-FOTS_{4%}, ZrP-FOTS_{7%}, and ZrP-PDMS (ZrP-TP₂), wherein the results indicate that the PFC- and PDMS-based coatings were at least 10-mm thick for all coated materials except ZrP-FOTS_{1%}, and each experiment was carried out three times (n=3).

FIG. 7 illustrates SEM images of uncoated ZrP in panel (a), ZrP-T in panel (b), ZrP-PDMS in panel (c), ZrP-FOTS_{1%} I panel (d), ZrP-FOTS_{4%} in panel (e), and ZrP-FOTS_{7%} in panel (f) at 100× and 10,000× magnification, wherein 100× images captured the size distribution and heterogeneity of each material, and 10,000× identified the reticulated surface of uncoated ZrP versus the other coated versions of ZrP; and wherein exposed, exchangeable surface area diminishes when aggregate size increases within a particle that is coated.

FIG. 8 illustrates the results of water contact angle or WCA studied for PDMS- and FOTS-coated ZrP materials, wherein each experiment was carried out three times (n=3).

FIG. 9A illustrates a competitive ion study on uncoated ZrP, ZrP-PDMS, and ZrP-FOTS_{4%} in 35-mM NH₄⁺, 35-mM Ca², and 20-mM HEPES water solution, wherein NH₄⁺ removal is illustrated in panel (a) and Ca²⁺ removal is illustrated in panel (b), wherein each experiment was carried out three times (n=3) and ZrP-PDMS and ZrP-FOTS_{4%} both removed 52% and 53% more NH₄⁺ than uncoated ZrP by 24-hours, respectively, and wherein ZrP-PDMS adsorbed 72% less Ca²⁺ then uncoated ZrP while ZrP-FOTS_{4%} did not adsorb any Ca²⁺.

FIG. 9B illustrates a competitive ion study of ZrP-FOTS at 4%, 7%, and 10% and ZrP-F₂ (No TEOS layer before adding FOTS) in 35-mM NH₄⁺ and 35-mM Ca²⁺, wherein NH₄⁺ removal is illustrated in panel in (a) and Ca²⁺ removal is illustrated in panels (b).

FIG. 10 illustrates SEM images in panel (a) and XPS results in panel (b) for ZrP-PDMS and ZrP-FOTS_{4%}; after exposure to hydrochloric acid (pH=2.5±0.5) for 3-hours, wherein the SEM images for both materials were visually similar to the images before acid exposure, XPS results indicated the PDMS coating may have been degraded after acid exposure while the FOTS results were similar to the results before acid exposure, and each XPS analysis was carried out three times (n=3)

FIG. 11 illustrates NH₄⁺ removal in panel (a) and Ca²⁺ removal in panel (b) over 24 hours by ZrP-PDMS and ZrP-FOTS_{4%} subsequent to acid exposure, wherein the materials were exposed to HCl_{(aq)} (pH=1.8) for 3 hours to replicate stomach acid conditions, the ion solution was identical to the solution used for removal studies before acid exposure in FIG. 9, each experiment was carried out three times (n=3), and the results showed ZrP-FOTS_{4%} maintained its selectivity for NH⁴⁺ and removal capacity while ZrP-PDMS selectivity decreased by approximately 72%.

FIG. 12 illustrates schematically that flexible PDMS chains (on the left side of the figure) have less orderly chain structure than rigid PFC chains, which exhibit a more orderly, packed chain structure.

FIG. 13 illustrates schematically a synthetic scheme in which a hydrogen loaded ZrP was first coated with activated TEOS to form a polysiloxane membrane on the exchanger's surface, which was then coated with either activated PDMS (top) or FOTS (bottom), wherein he wet chemistry used for all coatings was a straightforward silanization technique.

### DESCRIPTION

It will be readily understood that the components of the embodiments, as generally described and illustrated in the figures herein, may be arranged and designed in a wide variety of different configurations in addition to the described representative embodiments. Thus, the following more detailed description of the representative embodiments, as illustrated in the figures, is not intended to limit the scope of the embodiments, as claimed, but is merely illustrative of representative embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As used herein and in the appended claims, the singular forms “a,” “an”, and “the” include plural references unless the context clearly dictates otherwise. Thus, for example, reference to “a hydrophobic polymer” includes a plurality of such hydrophobic polymers and equivalents thereof known to those skilled in the art, and so forth, and reference to “a hydrophobic polymer” is a reference to one or more such hydrophobic polymers and equivalents thereof known to those skilled in the art, and so forth. Recitation of ranges of values herein are merely intended to serve as a shorthand method of referring individually to each separate value falling within the range. Unless otherwise indicated herein, each separate value, as well as intermediate ranges, are incorporated into the specification as if individually recited herein. All methods described herein can be performed in any suitable order unless otherwise indicated herein or otherwise clearly contraindicated by the text.

The devices, systems, methods, and compositions hereof may, for example, be used to reduce the concentration of a gas present in an aqueous environment which is in contact with the compositions hereof. The gas concentration may be reduced selectively. In a number of embodiments hereof, a gas-permeable and hydrophobic coating is formed upon a substrate which is a sorbent material. The gas-permeable and hydrophobic coating hereof may be a superhydrophobic coating (that is, having a water contact angle of 150° or greater). The solid substrate can take many forms such as sheets, membranes, conduits, channels, particles etc. In a number of embodiments, the solid substrate is or includes a solid particle including a sorbent material. Such solid particles may, for example, have average diameters in the nanoscale, microscale and/or millimeter range. Larger particles are also suitable for use herein. In embodiments in which particles are coated, such particles may be amorphous. In a number of embodiments, such particles may, for example, be on a microscale average diameter range as compared to a sheet- or membrane-like or a crystalline material on a larger size scale. The methods for forming the compositions hereof work effectively on the microscale level and do not result in excessive aggregation of the coated particles. Moreover, the methods of forming the gas-permeable and hydrophobic coating hereof do not significantly adversely affect the binding nature of the sorbent/ion exchange materials. The absorption/binding nature of the sorbent/ion exchange material is substantially maintained. In that regard, the absorption or binding capacity of the sorbent is desirably reduced by not more than 50% as result of coating with the gas-permeable and hydrophobic coating. Even more desirably, the absorption or binding capacity is reduced by no more than 30%, not more than 20% or no more than 10%. In general, it is desirable to minimize any reduction in adsorption or binding capacity of the sorbent during the coating process.

Studies hereof have demonstrated that high temperatures may significantly adversely affect the binding capacity of sorbents such as ion exchange materials. For example, the binding capacity of ZrP was found to be adversely affected at temperatures above 98° F. (36.7° C.). Various thermal coating techniques may significantly adversely affect the binding capacity of an ion exchange material. Relatively low temperature coating techniques are employed in a number of embodiments hereof.

A polymeric (for example, a polydimethylsiloxane (PDMS) perfluorooctyltriethoxysilane (FOTS), or other polymeric) coating may, for example, be applied by a method similar to standard drug tablet coating protocols. In such protocols, the target polymer is dissolved in a suitable solvent along with other additives (for example, fillers, plasticizers, etc.), then sprayed onto the surface of the substrate. In that regard, the polymer that is to serve as the coating film may be dissolved in a suitable solvent, together with any additives. Once those materials are mixed and homogenized, the solution is then sprayed onto the substrate. Finally the sprayed substrate is dried, which removes excess solvent and leaves a thin polymer coating on the substrate. A spray coating may also be applied by a process known as air-blast atomization in which a low-viscosity (for example, 20 cSt) polymer is diluted in a suitable solvent and deposited onto the surface via air-blast atomization. See, for example, Choonee, K.; Syms, R. R. A.; Zou, H., Post processing of microstructures by PDMS spray. Sensors and Actuators A. 2009, 253-262. doi:10.1016/j.sna.2009.08.029.

In a number of embodiments, the gas permeable and hydrophobic coating is formed by covalently attaching one or more hydrophobic polymers to a surface of the sorbent material (for example, a particle) via functional groups on the surface of the solid particle of the sorbent material. The synthetic schemes of the coating process may proceed under conditions that substantially maintain binding capacity. The hydrophobic polymers may be grafted to or grown from the surface of the solid substrate and may be formed using a variety of polymerization synthetic schemes (for example, condensation polymerization reactions, radical polymerizations reactions, living polymerizations reactions (sometimes referred to as controlled radical polymerization reactions or reversible-deactivation radical polymerizations reactions, etc.)

The term “polymer” refers generally to a molecule which may be of high relative molecular mass/weight, the structure of which includes repeat units derived, actually or conceptually, from molecules of low relative molecular mass (monomers). The term “copolymer” refers to a polymer including two or more dissimilar repeat units (including terpolymers—comprising three dissimilar repeat units—etc.). The term “oligomer” refers generally to a molecule of intermediate relative molecular mass, the structure of which includes a small plurality of units derived, actually or conceptually, from molecules of lower relative molecular mass (monomers). The term polymer, includes oligomers. In general, a polymer is a compound having >1, and more typically >10 repeat units or monomer units, while an oligomer is a compound having >1 and <20, and more typically less than ten repeat units or monomer units.

As used herein, the term “nanoscale” refers to a dimension in the range of 1 nanometer (nm) to less than 1 micron (μm). The term “microscale” refers to a dimension of 1 micron or greater to less than 1 millimeter (mm).

The coating methods hereof may be applied to generally any solid substrate material. In the case of methods herein in which the polymer is covalently attached to the solid substrate, the substrate may include (or be modified to include) accessible/exposed, reactive functional groups (for example, hydroxyl groups etc.) as known in the chemical arts. In a number of embodiments hereof, the coatings hereof have a thickness in the nanoscale range (that is, in the range of 1 nm to 1 μm). In a number of embodiments hereof in which the substrate is a solid particle substrate, the particles may, for example, have an average diameter in the range of 10-nm to 10-mm, in the range of 1 μm to 1 mm or in the range of 10 μm to 500 μm. In the case of an ingestible material (for example, a coated particle such a coated zirconium phosphate) the particles desirably have an average diameter greater than 10 μm (for example, according to FDA specifications). Increased surface area associated with solid particle substrates is desirable for improving binding rates. The ability to coat the substrates hereof (on, for example, the nanoscale range) for selective absorption of gas is an attractive feature for use in a number of industries/areas including, for example, the agriculture, waste-water, and carbon-capture industries. In a number of embodiments, coatings hereof can be applied to the inside of conduits such as tubes having inner-diameters ranging from, for example, 10-nm to 10-mm.

In a number of embodiments, the sorbent material of the substrates hereof is an ion exchange material (that is, a cation exchange material or an anion exchange material). A gas present in an aqueous environment in contact with the composition hereof can pass through gas permeable and hydrophobic coating of the compositions hereof. The gas may interact with one or more components or chemical species in the vicinity of the surface of the ion exchange material to create an ion for absorption. For example, NH₃ gas can cross a gas-permeable membrane and bind to H⁺ surrounding a cation exchange materials such ZrP, which has been loaded with hydrogen, to create NH₄⁺ which then binds to the ZrP. The hydrophobic nature of the coatings hereof allow the passage, permeation or diffusion of a gas such as NH₃ therethrough but limit the passage of ions in the aqueous environment to limit or prevent competition for binding sites by such ions.

Representative embodiments of devices, systems, methods, and compositions hereof are, for example, discussed in connection with the representative example of reduction of the amount of NH₃ in an aqueous/water environment. Devices, systems, methods, and compositions hereof may, for example, be particularly useful in form for internal use (for example, an ingestible form) to reduce the levels of NH₃/urea in a living organism (for example, a human) or in the removal of NH₃ from a dialysate. As clear to those skilled in the art, the hydrophobic, gas-permeable-coated sorbents hereof may be used generally for removal of various gasses other than NH₃ (for example, carbon dioxide or CO₂ via an anion exchange material) from aqueous environments using various sorbents materials (for example, ion/anion exchange materials, etc.). A sorbent for CO₂ may, for example, include an amine-based anion exchange material (for example, an amine-functionalize anion exchange resin material) within a gas-permeable and hydrophobic (or superhydrophobic) coating hereof.

Small intestine mucosa is highly permeable to urea. Urea is continuously transferred by diffusion from blood into the small intestine where it is catalyzed by bacteria to produce 2NH₃ and CO₂. 2NH₄⁺ and 2HCO₃⁻ are then formed in physiological solutions in presence of CO₂ and H₂O. NH₄⁺ and HCO₃⁻ are normally reabsorbed from the small intestine and return to the liver where urea is re-synthesized. An effective oral sorbent for NH₄⁺ in the small intestine could significantly decrease the blood level of urea in patients with ESKD. NH₄⁺ binding by an oral sorbent is optimal within the small intestine as a result of the high level of NH₄⁺ diffusion, permeability of the small intestine, and neutral pH range.

In a number of embodiments of devices, systems, methods, and compositions hereof, a selective NH₄⁺ sorbent is formed from non-selective, hydrogen-loaded cation exchanger. In that regard, binding selectivity for NH₄⁺ is improved by adding a gas-permeable and hydrophobic coating/membrane to the surface of a hydrogen-loaded cation exchanger. In a number of embodiments, a representative cation exchanger for use in the compositions hereof is ZrP, and the gas permeable and hydrophobic membrane is formed by covalent attachment of a hydrophobic polymer to the cation exchanger. NH₄⁺ is in equilibrium with NH₃ in any solution. As described above, NH₃ gas can cross a gas-permeable membrane and bind to H⁺ surrounding the ZrP to create NH₄⁺ which then binds to the ZrP. Because the membrane is also hydrophobic, it serves as a barrier to other ions in solution, which would otherwise compete with NH₄⁺ for binding on the ZrP.

Cation exchangers and other sorbents suitable for use herein, in embodiments with a covalently attached gas-permeable and hydrophobic coating, include functional groups on the surface thereof, or are modifiable to include such functional groups, to provide functionality for surface modification. For example, —OH groups on the surface of the representative cation exchanger ZrP's provide functionality for surface modification. In a number of representative embodiments, the hydrophobic polymer attached to a sorbent (for example, a cation exchanger such as ZrP) is, for example, a polysiloxane, a fluoro- or fluorinated polymer (for example, a polyfluorinated polymer of perfluoropolymer), an acrylate (for example, poly(methyl methacrylate), a polyurethane acrylate, a polyacetylene, an addition-type polynorbornene, a polymer of intrinsic microporosity (PIM), a low-density polyethylene, or a polyimide. As is known in the art, PIMs include a continuous network of interconnected intermolecular voids which may be less than 2 nm in width. Porosity in PIMs arises from a rigid and contorted macromolecular chains which do not efficiently pack in the solid state. Hydrophobic polymer coating layer(s) hereof may be polymer nanocomposite layers wherein the polymer matrix includes nanoparticles such as inorganic nanoparticles. A representative example of an inorganic nanoparticle is SiO₂. Such nanoparticles are typically between 1-100 nm or 10-100 nm in average diameter.

Polysiloxanes are suitable for use in the medical industry as coatings because of their proven low toxicity and biocompatibility. Polysiloxanes are also hydrophobic. In a number of representative embodiment of devices, systems, methods, and compositions hereof, a polysiloxane, hydrophobic layer was attached to a sorbent such as a cation exchanger via a multi-functional intermediate or linker such a tetraethyl orthosilicate (TEOS). For example, TEOS may be activated and applied to a hydroxyl-functional surface through a straightforward silanization technique. In the case of ZrP, the activated TEOS modifies the surface with a polysiloxane foundation—ZrP-T. Methoxy-terminated polydimethylsiloxane, for example, (m-PDMS) binds to the polysiloxane surface via silanization and forms the gas-permeable and hydrophobic membrane (ZrP-TP₂).

As described further below, in vitro experiments were designed to simulate expected small intestine ion concentrations and residence time. The studies were designed to capture batch-to-batch variation, binding capacity and kinetics, and selectivity of unmodified and modified forms of ZrP. Improved performance resulting from the polysiloxane foundation created via TEOS was quantified by comparing ZrP-TP₂ to m-PDMS bound directly to the ZrP surface (ZrP-P₂). The results quantified how a gas-permeable and hydrophobic membrane attached to a non-selective cation exchanger can improve its selectivity for NH₄⁺. X-ray photoelectron spectroscopy (XPS) was used to evaluate the progression of the coating process for both ZrP-TP₂ and ZrP-P₂. Water contact angle (WCA) tests determined the wettability of uncoated and coated ZrP. A more hydrophobic surface will hold back aqueous solution from the exchanger and improve its selectivity via transfer of ammonia gas (NH₃) across the membrane. Scanning electron microscopy (SEM) images compared ZrP before and after modifying its surface with PDMS. In vitro studies were designed to evaluate ZrP-TP₂'s applicability as an oral sorbent for treating ESKD patients.

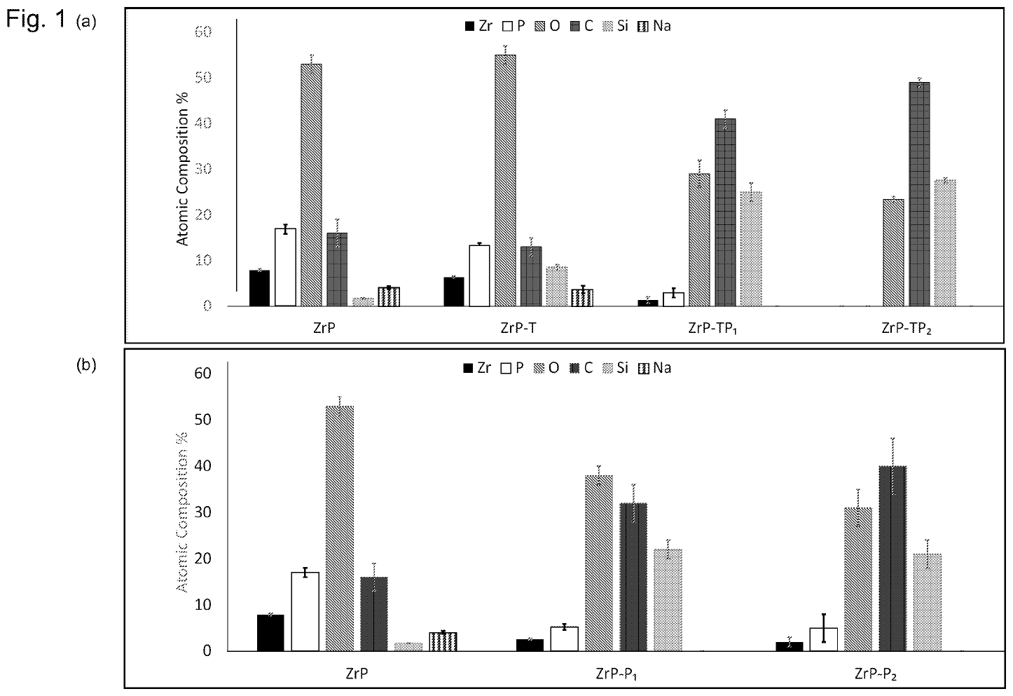

XPS surface analysis results shown in FIG. 1 compared the atomic composition changes between the ZrP-PDMS materials ZrP-TP₂ (panel (a)) and ZrP-P₂ (panel (b)) for the samples obtained from each coating process. The Zr and P compositions on the modified surfaces were gradually decreased by adding both TEOS and m-PDMS coating layers. In a number of embodiments, ZrP was coated with a layer of TEOS in forming ZrP-TP; and two layers of m-PDMS in forming ZrP-TP₂. ZrP-TP₂ results showed a shift toward the theoretical percentages of m-PDMS (O=25%, C=50%, and Si=25%) from the atomic percentages of uncoated ZrP (Zr=9.1%, P=18.2%, and O=72.7%) as the material was fully coated on the ZIP surface. The predicted m-PDMS coating thickness was at least 10 mm, since the takeoff angle of the XPS surface analysis was 90-degrees and quantifies atoms to a depth of 10-nm beneath the surface. The XPS data of ZrP-P₁ and ZrP-P₂ still showed Zr and P compositions, and those were very similar to one another which indicate the ZrP-P₂ coating protocol was less effective without adding a TEOS prime layer.

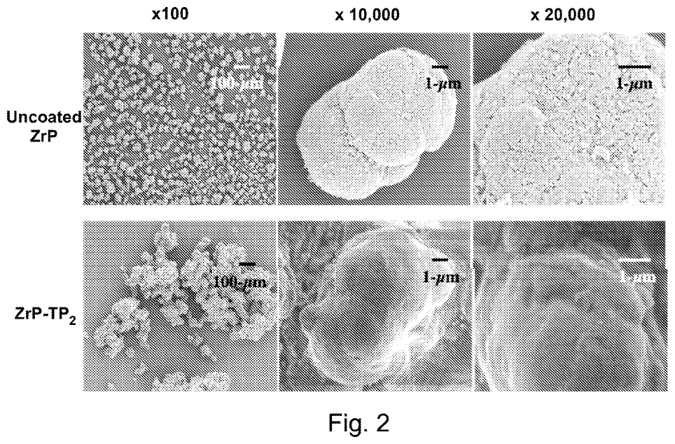

SEM images in FIG. 2 of uncoated ZrP show the raw material's heterogeneity, size distribution, and porous nature. Unmodified ZrP particles were measured to be 39-μm±3-μm (95% confidence interval or CI) and achieved the minimum size requirement given in Table 1 which sets forth small intestine scaling, simulation, and design targets and specifications. Targets and specifications may be different for uses other than ingestible materials for use in urea removal.

TABLE 1

| Design Categories | Design targets/specifications |
|---|---|
| Ingested amount | 150-g ZrP/Day. Patient will take 50-g ZrP |
| maximum | 3 times a day |
| Binding capacity | 1.60-mEq NH₄⁺/g ZrP @ 2-hours |
| and kinetics | |
| Selectivity | Bind no more than 48-mEq Ca²⁺ per dose |
| | of drug |
| Batch-to-batch | <10% variability |
| variation | |
| Material size | Diameter must be >10-μm |

SEM images showed the ZrP particles were comprised of 5-μm, roughly spherical particles adhered to one-another. The sphere surfaces were covered with 81-nm±20-nm (95% CI) diameter macropores. The openings were approximately 290 times greater in size than NH⁴⁺ (2.8-Å).

FIG. 2 also showed ZrP-TP₂ particles were 185-μm±26-μm (95% CI) in diameter. The particles were nearly five times larger than unmodified particles due to aggregation of the small particles. SEM images indicate no indentations or macropores were visible on the exterior of ZrP-TP₂ with the m-PDMS coating.

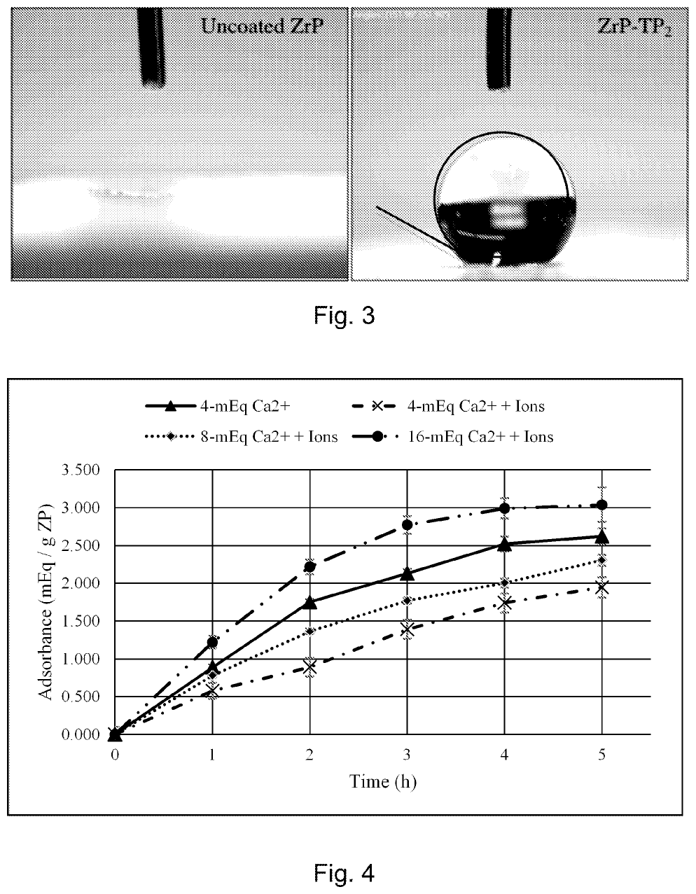

As shown in FIG. 3, uncoated ZrP, ZrP-T, ZrP-TP₁, ZrP-P₁, and ZrP-P₂ quickly absorbed the 2-μl . . . water droplet, i.e., WCA=˜0°. However, ZrP-TP₂ had a WCA of 149.8° (±2.5°).

Preliminary studies determined the appropriate [Ca²⁺] to use for making the small-intestine solution. Ca²⁺ bound over a 5-hour time course was quantified with and without the presence of other expected ions in the gut from Table 2.

TABLE 2

| Cation | Small Bowel (mM) | Mol Fraction |
|---|---|---|
| Ca²⁺ | 4.0 | 0.03 |
| Na⁺ | 138.0 | 0.87 |
| Mg²⁺ | 8.0 | 0.06 |
| K⁺ | 8.5 | 0.05 |

FIG. 4 illustrates the results of the study. Testing indicated unmodified ZrP binds 1.95-mEq Ca²⁺/g ZrP over 5-hours in physiologic levels of Na⁺, Mg²⁺, and K⁺. Total Ca²⁺ binding was 26% less than the control (2.62-mEq Ca²⁺/g ZrP). The decrease was significant since Ca²⁺ was only 3% of the total cations present in solution within the small intestine (FIG. 4) and results indicated that Ca²⁺ was the primary competing ion to NH₄⁻ on ZrP binding sites. [Ca²⁺ ] was increased to determine an ion solution [Ca²⁺] able to replicate the binding results of the control. Graphing the 5-hour Ca²⁺ binding results yielded a solution of 12-mM Ca²⁺ for replacing the other competing ions. 12-mM Ca²⁺ was used in all small intestine NH₄⁺ binding studies.

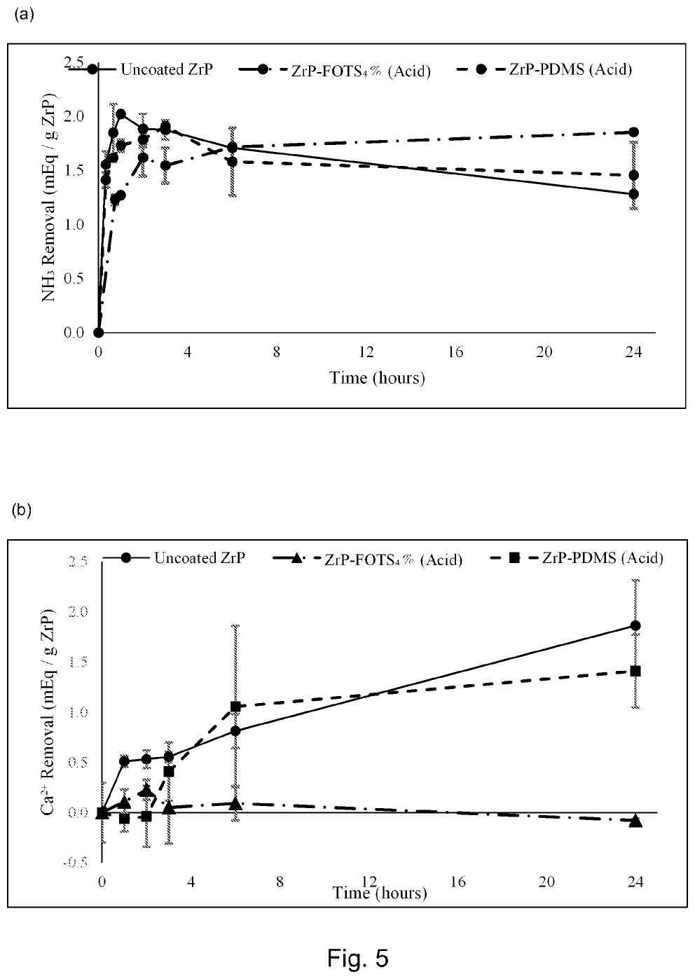

FIG. 5 provides the results of the simulated small intestine study for uncoated ZrP, ZrP-TP₂, and ZrP-P₂. Test tube solutions were renewed every 15-minutes over the course of the experiment. The four 15-minute samples from every hour were combined to determine the average ion absorption each hour. ZrP-TP₂ improved NH₄⁺ binding by 74% (1.99 vs 1.12 mEq/g ZrP, p<0.05) and 94% (2.91 vs 1.5 mEq/g ZrP, p<0.05) over control at 2- and 5-hour timepoints, respectively. ZrP-P₂ improved NH₄⁺ binding by 24% (p<0.05) and 22% (p<0.05) over control at 2- and 5-hour timepoints, respectively.

The results of FIG. 5 show that ZrP-TP₂ bound 59% more NH₄⁺ at 5-hours than ZrP-P₂. ZrP-TP₂ decreased Ca²⁺ binding by 80% (p<0.05) and 63% (p<0.05) over uncoated ZrP at 2- and 5-hour timepoints, respectively. ZrP-TP₂ selectivity for NH₄⁺ increased about four-fold over uncoated ZrP. ZrP-TP₂ satisfied the NH₄⁺ binding target threshold at approximately 1.5-hours. The control and ZrP-P₂ did not satisfy the NH₄⁺ 2-hour target threshold. Table 3 gives the total expected Ca²⁺ binding for all materials at both the 2 and 5-hour timepoints. ZrP-TP₂ was the only material to bind less than the maximum tolerable amount of Ca²⁺ (48-mEq) for both 2- and 5-hour time points.

TABLE 3

| | NH₄⁺ | Amount | Ca²⁺ | Total | Ca²⁺ |
|---|---|---|---|---|---|
| | binding | of ZrP | binding | Ca²⁺ | binding |
| | (mEq/g | required | (mEq/g | binding | threshold |
| | ZrP) | (g) | ZrP) | (mEq) | achieved |
| ZrP @ 2-h | 1.12 | 71 | 1.92 | 137 | No |
| ZrP @ 5-h | 1.50 | 50 | 2.38 | 119 | No |
| ZrP-TP₂ @ 2-h | 1.99 | 40 | 0.45 | 23 | Yes |
| ZrP-TP₂ @ 5-h | 2.91 | 28 | 0.87 | 24 | Yes |
| ZrP-P₂ @ 2-h | 1.39 | 58 | 1.00 | 58 | No |
| ZrP-P₂ @ 5-h | 1.83 | 44 | 1.92 | 85 | No |

Three batches of ZrP-TP₂ were developed and tested to determine batch-to-batch CoV % at 2-hours (4.3%) and 5-hours (2.8%). The results indicated the coating process achieved the 10% CoV % maximum target threshold from Table 1.

The above studies hereof demonstrated the development of gas-permeable and hydrophobic surface coating on cation exchange materials (for example, particles) through the representative embodiment of an amorphous form of ZrP using tetraethyl orthosilicate (TEOS) and methoxy-terminated polydimethylsiloxane (PDMS) to create the gas-permeable and hydrophobic surface coating. In vitro studies demonstrated that the coating or membrane functioned as a gas-permeable membrane while also serving as a hydrophobic barrier to other ions in aqueous solution. A number of studies demonstrated that thermal deposition coating methods eliminate a cation exchanger's (ZrP's) ability to function as a cation exchanger. However, a coating method utilizing surface functionality such as the —OH functional groups on ZrP resulted in retained cation exchange function. Acetone's relative safety, ability to dissolve the candidate form of PDMS, and volatility for self-removal after washing made it a desirable solvent for use in the methods hereof.

The simulated small intestine studies hereof demonstrated performance of the sorbents hereof under continuous ion exposure including NH₄⁺ which would result from transfer from the blood to the small intestine lumen. The studies showed ZrP-TP₂ improved selectivity for NH⁴⁺ by nearly 4-fold over uncoated ZrP while achieving the 2-hour NH⁴⁺ and Ca²⁺ binding target requirements described above. The results demonstrate that ZrP-TP₂ more than doubles NH⁴⁺ binding while decreasing Ca²⁺ absorption by more than 60% versus uncoated ZrP in the simulated intestine solution studies. ZrP-P₂ did not achieve the 2-hour NH⁴⁺ and Ca²⁺ binding goal. The material did reach the NH⁴⁺ binding target in 5-hours, but absorbed too much Ca²⁺. All ZrP coating and testing was performed in triplicate.

Without limitation to any mechanism, XPS surface analysis results suggested the reason for the improvement of selectivity on ZrP-TP₂ over ZrP-P₂ might be the result of differences in coating coverage. The atomic composition of ZrP-TP₂ showed no presence of Zr and P composition near the surface which indicated the improvement of the coating coverage from the ZrP-TP₁ showing Zr and P compositions. However, ZrP-P₂ showed no real improvement of the coating coverage as demonstrated by similar Zr and P compositions with the ZrP-P₁. The crosslinked TEOS prime layer, which increases —OH groups, might help to improve the m-PDMS reactivity and increase the total coating thickness. The SEM images of ZrP-TP₂ showed aggregation of ZrP particles during the coating development process. The size of the particles increased by nearly four-fold. The batch-to-batch results had a CoV % less than 10% and demonstrated the ability to repetitiously reproduce the modified ZrP material.

WCA results indicated ZrP-TP₂ was hydrophobic while ZrP-P₂ was not. The dramatic difference between ZrP-TP₂ and ZrP-P₂ indicated that an intermediate layer such as a TEOS layer was desirable to the coverage of the coating. Although ZrP also contains —OH groups, a network of a muti-functional entity such as TEOS renders the bonding of PDMS more probable, which results in better coverage. As a result, a hydrophobic membrane was formed and the diffusion of Ca²⁺ (in water solution) through the membrane was reduced. Because the membrane was gas permeable, it allowed NH₃ to permeate through, NH₄⁺ binding to ZrP was promoted over Ca²⁺.

The WCA of PDMS on a flat surface is approximately 116°. Previous studies have shown the WCA can be significantly increased if the surface contains a distribution of micro- and nano-sized topography features. ZrP-TP₂ particle sizes ranged from 10-μm to over 100-μm (see FIG. 2). The broad distribution of sizes yielded a distribution of bumps and valleys on the coating's surface. These features contributed to ZrP-TP₂'s super-hydrophobic nature (149.8°±2.5°).

The simulated small intestine solution testing of ZrP-TP₂ indicated a maximum NH₄⁺ binding capacity of 2.9-mEq/g ZrP and total ion binding (NH⁴⁺ and Ca²⁺) of 3.8-mEq ZrP at 5 hours. Previous work has demonstrated that unmodified ZrP total binding capacity could reach 7 to 8 mEq total ions/g. The studied PDMS-coated cation exchangers were not optimized. A few factors may contribute to a suboptimal total ion binding and define opportunities for improvement of performance via changes in, for example, coating protocol. For example, Ca²⁺ binding by ZrP-TP₂ suggests the membrane may not have perfect coverage. Gaps in coverage can result in Ca²⁺ getting through the coating to contact the ZrP particle as well as NH₄⁺ transporting out of the coating. Coated ZrP was also not wetted before being coated. Failure of complete wetting could cause binding sites within ZrP to not be accessible. Lower pH inside the membrane was another factor that could be limiting total capacity. A lower pH inside the membrane would assist in transfer of NH₃ across the membrane. But H⁺ also competes for binding sites thus potentially lowering binding capacity for NH₄⁺. XPS data indicated Na⁺ was still present in small amounts after ZrP was loaded with hydrogen. Na⁺ competes with NH₄⁺ for binding sites as well and ZrP binding capacity could be improved by further elimination of Na⁺. The XPS data also indicated carbon present on the surface of uncoated ZrP. The carbon could be from washing uncoated ZrP with ethanol before XPS analysis or environmental contamination. A careful cleaning process to remove the surface contamination may, for example, be conducted to improve the coverage. Moreover, conditions during the protocol may be adjusted to achieve improved coverage. For example, the pH may be adjusted. For example, lowering the pH from 5.5 to 4.5 or to 3.5 could improve the coverage. Although further optimization is possible, the PDMS-coated compositions hereof are suitable for use NH₄⁺ removal in a number of environment including liver disease treatment (as an ingestible treatment or as sorbent for dialysate), agricultural management, wastewater treatment, and/or other uses.

In another set of studies, fluorinated polymers were studied as an alternative hydrophobic and gas permeable coating. In a number of such representative studies, the representative fluorinated polymer was perfluorooctyltriethoxysilane (FOTS). In that regard, an FTOS coating was attached in place of PDMS (as described above) to a tetraethyl orthosilicate coated ZrP surface. Surface atomic composition analysis and scanning electron microscopy observation verified the successful application of the FOTS coating. Water contact angle analysis validated the FOTS coating was hydrophobic (145.0°±3.29). In vitro competing ion studies indicated the FOTS coating attached to ZrP increased NH₄⁺ removal by 53% versus uncoated ZrP. FOTS offers complete selectivity for NH₄⁺ over Ca²⁺ with similar NH₄⁺ capacity as the previous PDMS coating. Moreover, FOTS-coated ZrP maintained NH₄⁺ removal capacity and selectivity after the acid exposure study, indicating excellent acid resistance while NH₄⁺ selectivity of ZrP-PDMS decreased by 72%. The results suggested that FOTS-coated ZrP is promising as an oral sorbent for ESKD patients as well as for other uses as described above.

It was hypothesized that a more ordered fluorinate or perfluorinated carbon- (PFC-) based structure on ZrP's surface could improve both NH₄⁺ selectivity and removal capacity in the presence of other competing ions. Moreover, it was hypothesized that a PFC-based coating could also maintain its capacity and selectivity for NH₄⁺ after exposure to HCl_{(aq)} as a result of its greater chemical stability (including acid resistance) versus PDMS-based coatings. In that regard, fluorinated or PFC-based materials are very good candidates in, for example, oral delivery of an ESKD treatment as a result of their highly ordered packing structure, increased hydrophobicity, good gas permeability, and continued usage within the medical industry for devices, surgical procedures, and medical imaging methods. In vitro experiments compared the effect of FOTS-coated ZrP materials with the PDMS-coated materials described above. In the studies, a TEOS-based surface of ZrP (as described above) was coated with FOTS. The concentration of FOTS was varied to study optimization the coating properties. The resultant coatings were compared via a scanning electron microscopy (SEM). X-ray photoelectron spectrometry (XPS) and competing ion binding study before and after acid treatment were also studied. The acid stability of the FOTS-coated ZrP was also compared to PDMS-coated ZrP.

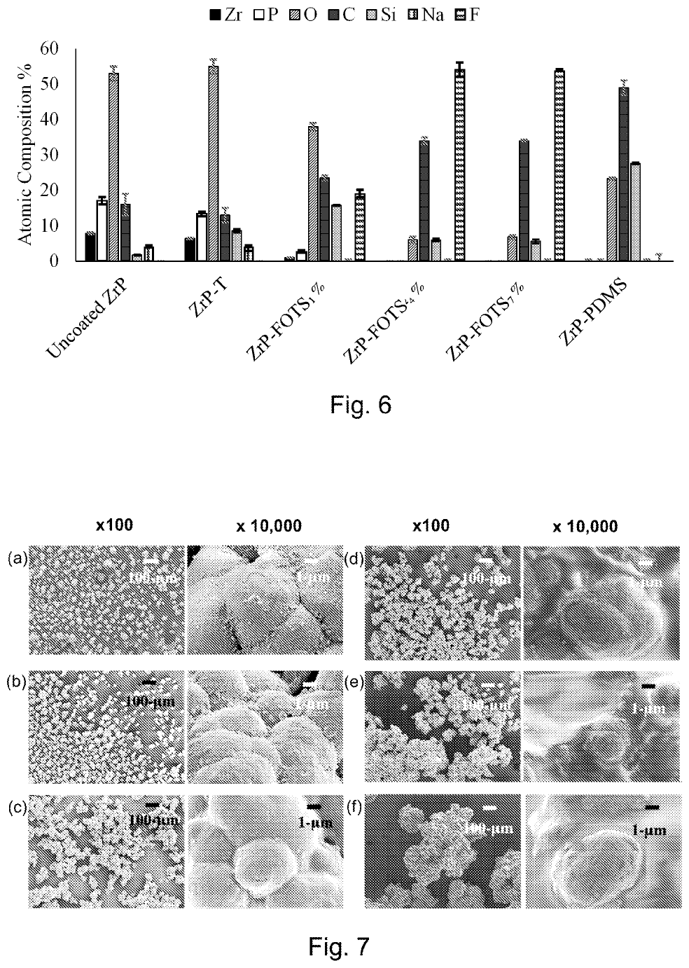

XPS surface analysis results shown in FIG. 6 include the atomic surface concentrations of uncoated ZrP, ZrP-FOTS_{1%}, ZrP-FOTS_{4%}, and ZrP-FOTS_{7%}. The Zr and P concentrations on all coated surfaces decreased after coating applications. Decreased Zr and P indicated the addition of a coating to ZrP's surface. ZrP-FOTS_{1%} had 50% less F on the surface than ZrP-FOTS_{4%}, and ZrP-FOTS_{7%}. ZrP-FOTS_{1%} surface concentration also had 6× more O than the other FOTS-coated materials. ZrP-FOTS_{4%} and ZrP-FOTS_{7%} results showed a shift toward the theoretical percentages of FOTS (F=52%, C=32%, Si=4%, and O=12%) from the atomic percentages of uncoated ZrP as the coating thickness increased. The FOTS coating was at least ˜10-mm thick for ZrP-FOTS_{4%} and ZrP-FOTS_{7%} since the take-off angle was 90-degrees and XPS quantifies atoms to a coating depth of ˜10-nm beneath the surface.

SEM images in FIG. 7 of uncoated ZrP, ZrP-T, ZrP-PDMS (ZrP-TP₂), ZxP-FOTS_{1%}, ZrP-FOTS_{4%}, and ZrP-FOTS_{7%} showed the heterogeneity, size distribution, and degree of coating for each material. ZrP-T coated with TEOS had a slightly more irregular and continuous appearance compared to uncoated ZrP. ZrP-PDMS aggregates were approximately 375% larger than uncoated ZrP. FOTS coated ZrP size increased with FOTS concentration from 1% (45-mm±5-mm) to 4% (63-mm±10-mm) to 7% (170-mm±79-mm). ZrP-FOTS_{1%} surface texture was similar to uncoated ZrP. ZrP-FOTS_{4%} size was 40% larger than ZrP-FOTS_{1%}. The surface of ZrP-FOTS_{4%} appeared completely covered with FOTS and the reticulated ZrP texture was not visible. ZrP-FOTS_{7%} size was 170% larger than ZrP-FOTS_{4%}.

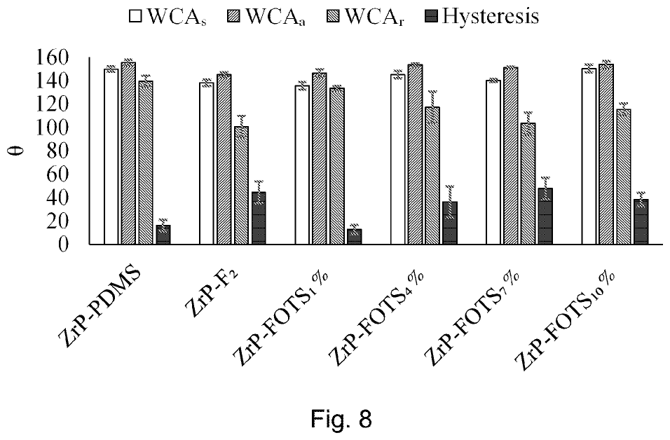

WCA studies investigated WCAₛ, WCAₐ, WCAᵣ and hysteresis for ZrP-PDMS, ZrP-FOTS_{1%}, ZrP-FOTS_{4%}, and ZrP-FOTS_{7%}. The results are given in FIG. 8. ZrP-FOTS_{1%} had the lowest WCAₛ and WCAₐ of 135.6° (±3.46) and 138.1 (±2.7°), respectively. The material's WCAₐ was the only one less than 150°. ZrP-FOTS_{4%} had a WCAₛ of 145.0° (±3.2°) and WCAₐ of 153.5° (±1.5°). ZrP-PDMS WCAₛ and WCAₐ were similar to ZrP-FOTS_{4%}, though the hysteresis for ZrP-PDMS was nearly 50% less due to lower receding angles on the FOTS coated structure.

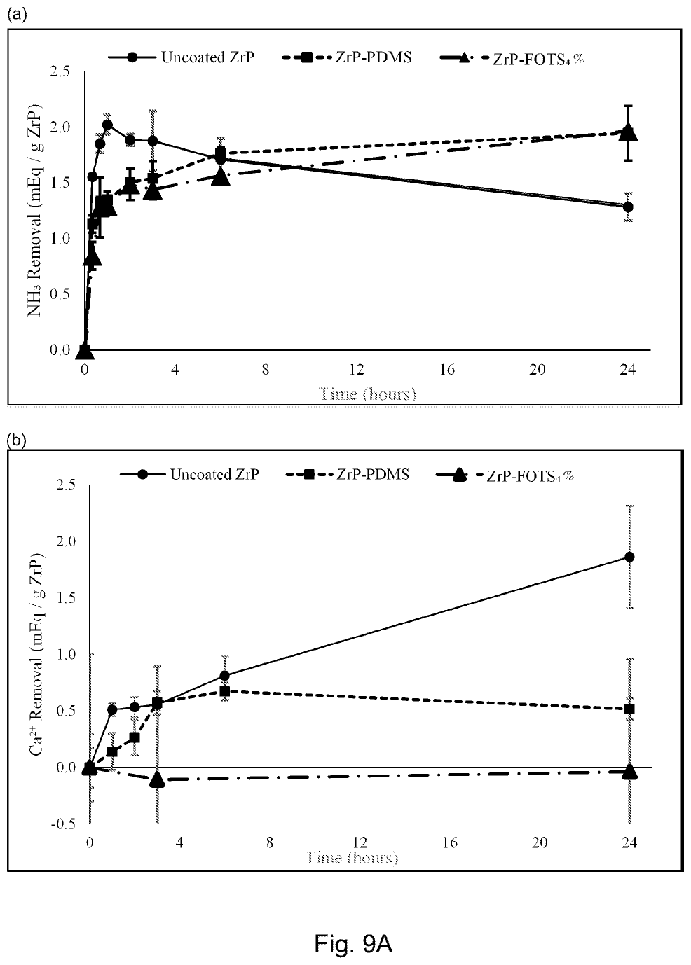

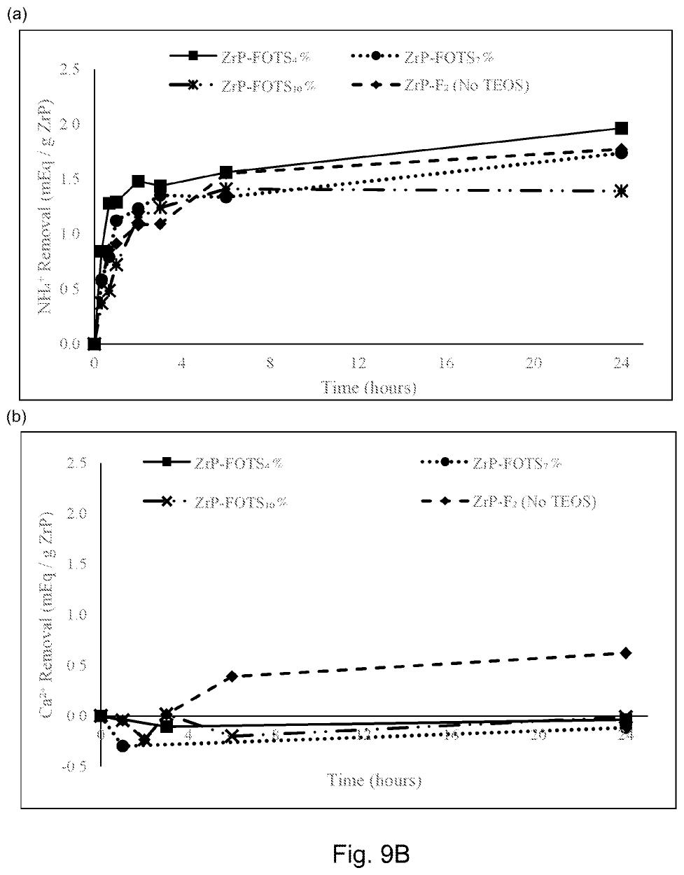

FIG. 9A provides the results of the in vitro competitive ion study for uncoated ZrP, ZrP-PDMS, and ZrP-FOTS_{4%}. The results of ZrP-FOTS 1%, 4%, 7% and 10% are set forth in FIG. 9B. Referring to FIG. 9A, uncoated ZrP quickly removed 2.02 (±0.09) mEq NH₄⁺/g ZrP within the first hour of the study from the testing solution. But by 24 hours, uncoated ZrP's NH₄⁺ removal decreased by 37% to 1.28 (±0.12). ZrP-PDMS removed 1.35 (±0.08) within the first hour and continued removing NH₄⁺ throughout 24 hours to reach 1.94 (±0.24). ZrP-PDMS increased total NH₄⁺ removal of ZrP by 52% (1.94 vs 1.28, p<0.05) versus uncoated ZrP at the 24-hour timepoint. ZrP-FOTS_{4%}, removed 1.29 (±0.02) within the first hour. The result had no meaningful statistical difference from ZrP-PDMS (p=0.15). ZrP-FOTS_{4%} removed 1.96 (±0.02) by the 24-hour mark—a 53% increase over uncoated ZrP (p<0.05), but no meaningful statistical difference from ZrP-PDMS (p=0.45).

Uncoated ZrP removed 1.86 (±0.45) mEq Ca²⁺/g ZrP from the testing solution by the end of the 24-hour test. ZrP-PDMS reduced Ca²⁺ removal by 72% (p<0.05) compared to uncoated ZrP. ZrP-FOTS_{4%} and higher FOTS concentrations did not remove any Ca²⁺ throughout the test. The uncoated ZrP selectivity ratio for NH₄⁺ at 24 hours was 0.64. ZrP-PDMS selectivity ratio for NH₄⁺ was 3.73 and was 5.4 times greater than uncoated ZrP (p<0.05). ZrP-FOTS_{4%} showed complete selectivity for NH₄⁺ as no Ca²⁺ removal was detected (p<0.05).

Referring to FIG. 9B, assessing ZrP-FOTS_{4%} versus ZrP-F₂ showed the advantage of first coating the material with TEOS to form a polysiloxane membrane for optimal NH₄⁺ selectivity. ZrP-F₂ selectivity was nearly three times better than uncoated ZrP, but ultimately did not achieve the same degree of selectivity as ZrP-FOTS_{4%}. ZIP-Fz also removed 33% less NH₄⁺ than both ZrP-PDMS and ZrP-FOTS_{4%} by the 1 hour timepoint. The polysiloxane membrane increased the abundance of available —OH groups for attachment of the gas-permeable and hydrophobic monomers.

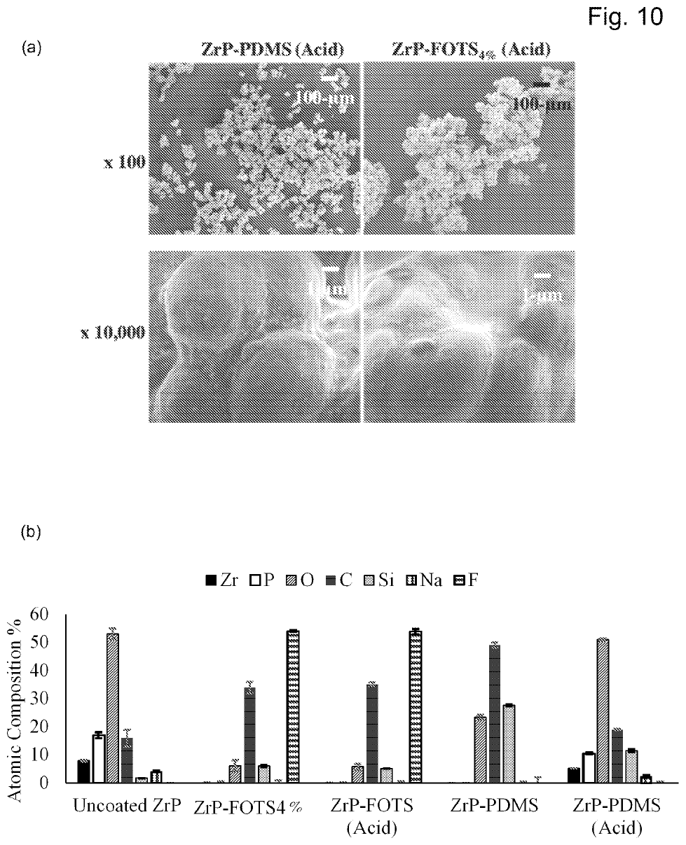

SEM images and WCA results were collected of ZrP-PDMS and ZrP-FOTS_{4%} materials after acid exposure and are given in FIG. 10. SEM images in panel (a) of FIG. 10, after the acid treatment, at 10,000× showed both ZrP-PDMS and ZrP-FOTS_{4%} still coated with their respective coatings. The materials were visually similar to the SEM and WCA results before acid exposure. The 100× zoom appeared to show changes in size of the PDMS and FOTS-coated materials. XPS results in panel (b) of FIG. 10 show no change to ZrP-FOTS_{4%} when compared to FIG. 7. However, the PDMS layer of ZrP-PDMS (ZrP-TP₂) appeared to be affected by acid treatment. ZrP-PDMS, after acid exposure results, appeared to be more similar to uncoated ZrP than to ZrP-PDMS with increasing Zr and P composition. WCA results indicated the materials maintained their degree of hydrophobicity with no large decreases observed.

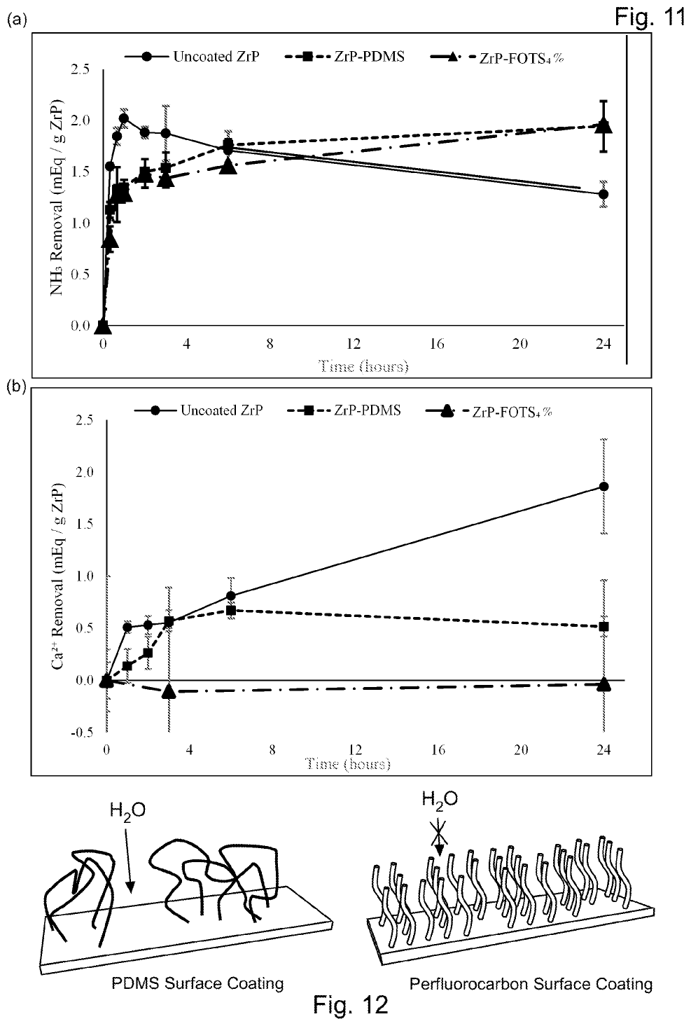

FIG. 11 provides the results of the in vitro competitive ion study for acid-exposed ZrP-PDMS and ZrP-FOTS_{4%} relative to uncoated ZrP. Uncoated ZrP removed 2.02 (±0.09) within the first hour. As illustrated in panel (a) of FIG. 10, acid-exposed ZrP-PDMS removed 1.73 (±0.05) mEq NH₄⁺/g ZIP within the first hour of testing and had a 30% increase in total removal versus ZrP-PDMS before acid exposure. Acid exposed ZrP-PDMS' total NH₄⁺ removal at 24 hours decreased by nearly 25% to 1.46 (±0.31) versus unexposed ZrP-PDMS (p<0.05). The difference in NH₄⁺ removal between uncoated ZrP and acid exposed ZrP-PDMS was not statistically significant (p=0.21). Acid exposed ZrP-FOTS_{4%} removed 1.27 (±0.01) within the first hour of the study. The total removal at the same time point by unexposed ZrP-FOTS_{4%} was very similar (1.27). Acid exposed ZrP-FOTS_{4%} continued removing NH₄⁺ from solution throughout the test and 1.85 (±0.01) by the end of the study. The result was a 5% decrease from unexposed ZrP-FOTS_{4%} (p<0.05). Acid exposed ZrP-FOTS_{4%} removed 27% more NH₄⁺ than acid exposed ZrP-PDMS (p<0.05) and 46% more than uncoated ZrP (p<0.05) within the study.

As illustrated in panel (b) of FIG. 11, acid-exposed ZrP-PDMS removed 1.41 (±0.36) mEq Ca²⁺/g ZrP total over the time course of the study. The result was an increase in total Ca²⁺ removal compared to ZrP-PDMS before acid exposure (p<0.05). Acid exposed ZrP-PDMS removed a similar amount of Ca²⁺ as uncoated ZrP. ZrP-FOTS_{4%} after acid exposure did not remove any Ca²⁺. Acid-exposed ZrP-PDMS selectivity for NH₄⁺ decreased by 72% from 3.73 (unexposed to acid) to 1.04. Acid exposed ZrP-FOTS_{4%} remained completely selective for NH₄⁺ over Ca²⁺.

The competing ion studies showed ZrP-FOTS_{4%}, capable of removing as much NH₄⁺ as ZrP-PDMS within a solution of 35-mM NH₄⁺, 35-mM Ca²⁺, and 20-mM HEPES and a starting pH of 8.0 (±0.5), but with no removal of Ca²⁺. SEM images of FOTS-coated ZrP showed high FOTS concentration results in larger molecules and better coverage. With increase of coating thickness, selectivity increases since water and ion transfer across the membrane is prevented. But total NH₄⁺ removal within 24-hours may decrease if the membrane is too thick. The selectivity and binding capacity results of the competing ion studies in this work showed there was an optimal % FOTS at 4% in the studies hereof. Uncoated ZrP's NH₄⁺ removal decreased by 37% from its reported 1-hour value (2.02-mEq/g ZrP) while the other coated materials did not lose NH₄⁺. The hydrophobic nature of the PDMS-based coating significantly decreased the abundance of Ca²⁺ near the cation-exchanging surface versus uncoated ZrP. And the FOTS-based coating completely eliminated Ca²⁺ as a competing ion for ZrP binding sites.

The pH of the in vitro studies was not maintained as it would be within the small intestine, and pH decreased approximately a whole unit for ZrP-FOTS_{4%} from start of each binding study to the end. pH decreasing by a unit decreases available NH; by 90%. NH; is in equilibrium with NH₄⁺ and the ratio of NH₃:NH₄⁺ is driven by pH. Coatings completely selective for NH₃ over other competing ions could also be limited by available NH₃ by the end of the study. When the coated sorbents remove NH₃ from a solution of NH₄⁺, there is a free H⁺ left in solution. It is possible that the capacity for NH₄⁺ removal by FOTS-coated ZrP could be increased significantly if the pH of the solution is held constant as NH₃ is removed. Studies in simulated small intestinal fluid maintained a pH of about 8 and showed improvement in binding of NH₄⁺ by coated ZrP.

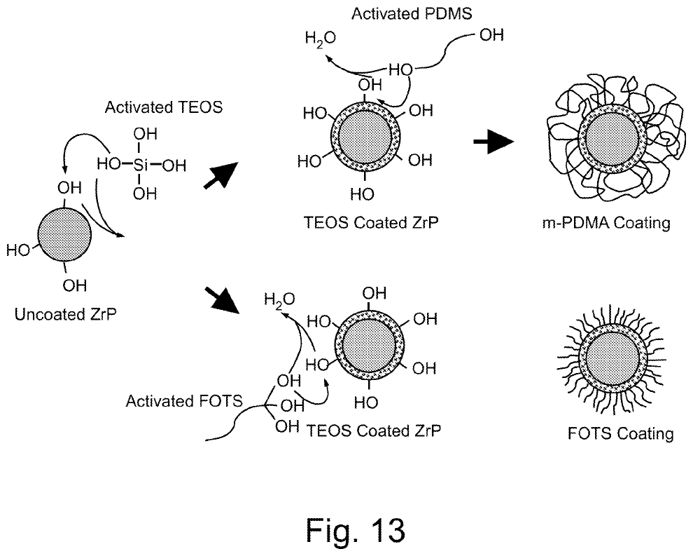

As, for example, illustrated schematically in FIGS. 12 and 13, PFC-based coatings offer a more rigid chain structure on the surface and were thus selected as the alternative coating material in the above studies. A more rigid chain provides a more orderly packed chain structure and thus more efficient coverage, which would be impermeable to most small molecules. In general, a flexible polymer chain is less orderly packed and may not provide good coverage. Moreover, higher mobility of flexible polymer chains results in transient dynamic “holes”. i.e., chain-to-chain distance increases due to the motion of polymer segments. The water solution and ions can then gradually pass through such a membrane and interact with the cation exchanger. PDMS is a flexible polymer by design, which might explain the imperfect selectivity for NH₄⁺ in representative studies hereof. FIG. 12 illustrates schematically the hypothetical different chain structure between PDMS and PFC coatings.

The more ordered structure of PFC-based coatings could lead to lower NH₃ permeability compared to PDMS-based coatings, resulting in lower binding of NH₃ by the cation exchanger. Increased concentrations of FOTS in coating solution could further hinder total NH₄⁺ removal capacity by physically covering ion exchange sites on or within the ZrP. The studies hereof showed ZrP-FOTS_{4%} and ZrP-FOTS_{7%} both achieved complete selectivity for NH₄⁺. But ZrP-FOTS_{4%} performed better than the other two materials and ZrP-FOTS_{4%} removed 79% more NH₄⁺ from solution than ZrP-FOTS_{10%} by the 1-hour timepoint.

PFC's biological inertness and gas permeability has led to its use in the development of a potential synthetic oxygen-carrier material. FOTS has a reported static WCA of 150° on a substrate with the desired micro-structure, categorizing the material as superhydrophobic.

In use in an oral method to treat ESKD, for example, coated ZrP will pass through the stomach after ingestion before entering the small intestine. Low stomach pH could adversely affect the gas-permeable membrane. The pH of the stomach varies between 1 and 5 with a residence time up to 3 hours. The pH level of the stomach rises and falls with ingestion of food. Modified ZrP as an oral sorbent must maintain its function after exposure to stomach acid conditions. The most common pH level within an individual's stomach is between 1.5 and 2.0. PDMS has been reported to degrade from acid exposure, while PFC-based coatings like FOTS are known for their chemical inertness and stability.

Acid treated ZrP-FOTS_{4%}, maintained complete NH₄⁺ selectivity over the 24-hour study. But ZrP-PDMS NH₄⁺ selectivity decreased by over 70% as a result of acid exposure. XPS results of ZrP-PDMS after acid exposure indicated the PDMS coating may have been degraded. The impact of acid on ZrP-PDMS was apparent with the quick, upfront removal of NH₄⁺ similar to uncoated ZrP. PDMS degradation could reasonably explain the results for ZrP-PDMS after acid exposure. Acid exposure studies showed a clear advantage for PFC-based coatings over PDMS in acidic environments such as present in the human stomach. A previous assessed PDMS degradation when exposed to pH values from 2 to 4 and 9 to 12 over multiple days, and demonstrated that silicones can decompose via hydrolysis. The study found that all forms of PDMS will decay to some extent in both alkaline and acidic conditions with —OH terminated PDMS decaying the most (an order of magnitude greater decay). A degraded PDMS coating may yield an increased rate of water solution reaching the cation exchanger and Ca²⁺ ions along with it. Acid-treated ZrP-FOTS_{4%} adsorption was very similar to the results before acid exposure. One of the attractive features of PFC-based coatings for this application is the demonstrated chemical stability and inertness they exhibit. FOTS also offers three linking groups to the surface of ZrP per molecule, whereas m-PDMS offers only one group per end. The added groups on FOTS could yield a higher degree of crosslinking and thus stronger resistance to pH degradation. The improved acid resistance of ZrP-FOTS_{4%}, versus ZrP-PDMS indicated the PFC-based coatings are a better option as an oral sorbent for ESKD patients.

SEMs of ZrP-FOTS_{4%} indicated FOTS-coated ZrP particles attached to other nearby coated ZrP particles after acid exposure. Acid exposure could have activated unreacted ethoxy groups on FOTS that may have not been activated during the coating process. The overall impact on NH₄⁺ total removal was minimal.

In summary, both PDMS-based coatings and FOTS-based coatings on ZrP demonstrated improved NH₄⁺ removal capacity over uncoated ZrP. While PDMS-based coatings demonstrated partial selectivity for NH₄⁺ over Ca²⁺, FOTS-based coating demonstrated complete selectivity for NH₄⁺ over Ca²⁺, as well as acid resistance. XPS surface analysis, WCA, and SEM results indicated successful coating of the ZrP surface for both PDMS and FOTS-based coatings. PDMS-coated ZrP did not maintain its selectivity after acid exposure, but FOTS did. The results showed that ZrP-FOTS_{4%} maintained its selectivity and capacity while ZrP-PDMS selectivity decreased by 72%. ZrP-FOTS_{4%}'s complete selectivity for NH₄⁺ and pH resistance were key improvements over ZrP-PDMS. The more rigid and orderly-packed PFC-based chain may have diminished water penetrating the coating. The binding results indicated that the best-performing FOTS coatings studied herein (that is, ZrP-FOTS_{4%}), offered both complete selectivity for NH₄⁺ in the presence of Ca²⁺ and improved total capacity by nearly 25% over ZrP-FOTS_{7%}.

It is desirable that the capacity of an oral sorbent for NH₃ is as high as possible to increase the probability that product will be well tolerated by patients and create clinical benefit in ESKD and/or liver-disease treatment. In vitro studies of hydrogen-loaded of the representative sorbent ZrP have shown a maximum binding capacity for NH₄⁺ at 4 mEq/g or more. Although such a binding capacity demonstrates suitability of the devices, systems, methods and compositions hereof in disease treatment and other uses, the binding of NH₃ by coated ZrP compositions hereof is at most approximately ½ the theoretical potential binding capacity. Further optimization of, for example, NH₄⁺ removal capacity is possible (for example, by maintaining a higher pH throughout the removal process). Nonetheless, the devices, systems, methods and composition hereof are useful in, for example, NH₄⁺ removal in ESKD and liver disease treatment, agricultural management, and wastewater treatment, and/or other uses.

### EXPERIMENTAL

Materials. Amorphous ZrP in granular form (39-μm±3-μm) was provided by HemoCleanse Technologies LLC. (Lafayette, IN), loaded almost entirely with hydrogen (but with some residual sodium). Hydrochloric acid (CAS No: 7647-01-0), HEPES sodium salt (CAS No: 75277-39-3), acetone (CAS No: 67-64-1), calcium chloride (CAS No: 10043-52-4), and ammonium chloride (CAS No: 12125-02-9), were purchased from Sigma Aldrich (St. Louis, MO). Tetraethyl Orthosilicate (CAS No: 78-10-4) was purchased from Geleste, Inc. (Morrisville, PA). 1H,1H,2H,2H-Perfluorooctyltriethoxysilane, 97% (CAS No: 51851-37-7) was purchased from Fisher Scientific (Waltham, MA). Urea Nitrogen used to measure total of NH₄⁺ and NH₃ (CAS No: B551-132) and calcium (CAS No: C503-480) colorimetric testing kits were purchased from Teco Diagnostics (Anaheim, CA). All water in experiments was deionized (DI). Colorimetric testing kits from Teco Diagnostics were used to quantify NH₄⁺ and Ca²⁺ levels in solution. Color development assays were prepared according to the instructions given with each kit. [NH₄⁺] and [Ca²⁺] were quantified using a Genesys SIO UV-VIS monochromator. The monochromator was set to wavelengths 570-nm (blue/green) and 630-nm (violet) for Ca²⁺ and NH₄⁺ measurements, respectively. 3-mL cuvettes used for the studies were purchased from Cole-Parmer with a 10-mm pathlength (CAS No: 759075D), 4.5-mL cuvettes used for the studies were purchased from Fisher Scientific with a 10-mm pathlength (CAS No: S29159).

ZrP Coating and the Characterizations. Amorphous ZrP was coated with TEOS and m-PDMS using a standard silanization technique. See Hermanson, G. T. Bioconjugate Techniques, 3^{rd} Ed., Elsevier Inc., 2013, the disclosure of which is incorporated herein by reference. 1-mL of TEOS and 1-mL of deionized (DI) water were added to a 50-mL falcon tube. 20-mL of acetone was then poured into the solution to combine the two layers (pH=6.5±0.5). A 1-cm stir bar was placed inside the tube and the tube was capped. The capped falcon tube was placed over a stir plate and mixed at 450-rpm for 2-hours. Uncoated ZrP (1.00-g+/−0.005 g) was added to the solution after mixing. The tube was capped and placed on a rocker panel at room temperature for 12-hours at 30-rpm. The falcon tube was removed from the rocker panel and positioned upright in a test-tube holder, undisturbed for 2-hours. Effluent above the undisturbed ZrP bed was then removed and ZrP was gently washed with acetone. The uncapped tube was placed inside a low-moisture chamber at room temperature for curing (72-hours). The resulting product (ZrP-T) was washed with acetone and DI water then placed in a falcon tube. 1-mL of m-PDMS and 1-ml of DI water were added to another falcon tube. 40-mL of acetone was added into the solution to combine the two layers (pH=6.5±0.5). The remaining curing step used for TEOS membrane formation was repeated for m-PDMS surface attachment (ZrP-TP₁). The m-PDMS coating protocol was repeated once more to give ZrP-TP₂. We then coated additional ZrP but left out TEOS to understand the effect of the TEOS layer (ZrP-P₂). The scheme of FIG. 13 summarizes the coating process. In that process, hydrogen-loaded ZrP was first coated with activated TEOS and formed a polysiloxane layer over the surface of ZrP. Activated m-PDMS was then attached to the surface of the polysiloxane layer and formed the gas-permeable membrane (ZrP-T). The m-PDMS coating process was carried out twice and formed ZrP-TP₂. As described above, the chemistry used for all attachments was a common silanization technique.

In the case of FOTS coatings, amorphous ZrP was coated with TEOS and FOTS using a standard silanization technique. 1-mL of TEOS and 1-mL of deionized (DI) water were added to a 50-mL falcon tube. 20-mL of acetone was then poured into the solution to combine the two layers (pH=5.5±0.5). A 1-cm stir bar was placed inside the tube and the tube was capped. The capped falcon tube was placed on a rocking panel for 2-hours. Uncoated ZrP (1.00-g+/−0.005 g) was added to the solution after mixing. The tube was capped and placed on a rocker panel at room temperature overnight at 30-rpm (pH=5.5±0.5). The falcon tube was removed from the rocker panel and positioned upright in a test-tube holder, undisturbed for 2-hours. Effluent above the undisturbed ZrP bed was then removed with a disposable pipette and ZrP was gently washed with acetone. The uncapped tube was placed inside a low-moisture chamber at room temperature for curing (72-hours). The resulting product (ZrP-T) was washed with acetone and DI water then placed in a falcon tube.

Three separate batches of each of the 5 materials were made with varying concentrations of FOTS and DI water in 10-mL of acetone. The concentration of FOTS in acetone during the coating process was varied between 0.1% and 10% for different batches of modified ZrP to evaluate the impact that thickness of the PFC-based membrane could have on NH₄⁺ total removal from water solution. The preparation and designated names are given in Table 4.

TABLE 4

| Material | DI Water | FOTS Material | FOTS % of 10-mL |
|---|---|---|---|
| Nomenclature | Added | Added | Solution |
| ZrP-FOTS_{0.1%} | 10-mL | 10-mL | 0.1% |
| ZrP-FOTS_{1.0%} | 100-mL | 100-mL | 1.0% |
| ZrP-FOTS_{4.0%} | 400-mL | 400-mL | 4.0% |
| ZrP-FOTS_{7.0%} | 700-mL | 700-mL | 7.0% |
| ZrP-FOTS_{10.0%} | 1,000-mL | 1,000-mL | 10.0% |

Designated amounts of FOTS and DI water from Table 4 were added to a falcon tube for each of the five materials. 10-mL of acetone was added into the solution to combine the two layers (pH=5.5±0.5). The curing step used for TEOS membrane formation was repeated for FOTS surface attachment (ZrP-FOTS). Additional ZrP was then coated with 10% FOTS (twice) without first coating by TEOS (ZrP-F₂) to compare to coatings with the TEOS layer. The PDMS coating protocol used in creating PDMS-coated ZrP for comparison studies was the same as set forth above. In the comparison studies, m-PDMS coating protocol was repeated a second time (to synthesize ZrP-TP₂ as described above). FIG. 13 illustrates the synthesis schemes for each of PDMS-coated and FTOS-coated ZrP.

Atomic surface composition. Atomic composition was determined by surface analysis via X-ray Photoelectron Spectroscopy. XPS spectra were taken on a Surface Science Instrument S-Probe spectrometer. This instrument had a monochromatized A1 x-ray source and a low energy electron flood gun for charge neutralization. X-ray spot size for these acquisitions was 800×800-μm. Pressure in the analytical chamber during spectral acquisition was below 1×10⁻⁸ Torr. Pass energy for composition was 150-eV. Data analysis was carried out using the service Physics Hawk & Analysis program (Service Physics, Bend OR). The takeoff angle of the XPS surface analysis was 90-degrees and quantifies atoms to a depth of 10-nm beneath the surface.

In the comparative studies of PDMS- and FTOS-coated ZrP, the atomic surface composition of both PDMS- and FOTS-coated materials was determined via surface analysis using XPS. A detail scan was run for Zr, F, P, Si, and Na to improve quantification. Data analysis was carried out using the Service Physics Hawk Analysis 7 program (Service Physics, Bend OR). Each sample was pressed flat onto a piece of double-sided Scotch tape that was adhered to a clean silicon wafer. The samples were then adhered to the sample holder with double-sided scotch tape. The samples were handled with solvent-cleaned tweezers while wearing polyethylene gloves. Three spots on each sample were chosen for analysis.

SEM imaging. SEM images were collected using a JSM 6335F SEM (JEOL Ltd., Japan). The instrument has a magnification range from 10× up to 500,000×. The images were, for example, taken of unmodified and modified ZrP (ZrP-TP₂) to quantify changes to particle and size of openings seen on the reticulated surface before and after the coating process. Particle sizes were measured via a 100× magnification (n=123 and 47, respectively). The surface of ZrP was photographed at up to 50,000× magnification. The images were also used to determine the presence of the coating.

In the comparative studies of PDMS- and FTOS-coated ZrP, SEM images were collected for both PDMS- and FOTS-coated materials using the JSM 6335F SEM. Particle sizes were measured and heterogeneity determined via a 100× magnification. The size was determined by measuring the horizontal and perpendicular diameters of the particles. The surfaces of the different ZrP coatings were assessed at 10,000×.

Wettability of uncoated and coated ZrP was characterized by WCA. The WCA testing method used in this study was adapted from previous work. See. Gong, X.; Bartlett, A.; Kozbial, A.; Li, L. A Cost-Effective Approach to Fabricate Superhydrophobic Coatings Using Hydrophilic Materials. Adv. Eng. Mater. 2015, the disclosure of which is incorporated herein by reference. The tests were orchestrated using a VCA Optima XE system (AST Products, Inc., Massachusetts) at room temperature and 48% humidity. Briefly, the sample was gently pressed flat on the surface of a microscope plate using a flat, metal spatula to a 1-mm thickness. The plate was then placed on the VCA instrument platform directly underneath a syringe filled with DI water. A 2-μL water droplet was formed at the end of the syringe needle. The platform holding the microscope plate was then carefully elevated to the water droplet. The needle was then with drawn to leave the droplet resting on the surface of the material. An image of the droplet was then taken using a charge-coupled device camera, and the value of the static WCA was determined by the VCA software. The experiment was carried out three times (n=3) and results were averaged to determine the WCA for each material.

In the comparative studies of PDMS- and FTOS-coated ZIP, wettability of ZrP-PDMS, ZIP-FOTS_{1%}, ZrP-FOTS_{4%}, and ZrP-FOTS_{7%} was characterized via water contact angle (WCA) methods WCAₛ (static), WCAₐ (advancing), and WCAᵣ (receding). The materials were analyzed using the VCA Optima XE system at room temperature and 48% humidity. 50-mg samples of each material were pressed into pellets using a pellet press. The pellets formed from the material were then placed on the VCA instrument platform directly underneath a syringe filled with DI water. WCAₛ data was collected by forming a 1 to 2-mL droplet on the tip of the syringe. The platform holding the pellet was then carefully elevated to the water droplet. The needle was then withdrawn to leave the droplet resting on the surface of the material. An image of the droplet was then taken using a charged-couple device camera, and the value of WCAₛ was determined via VCA software. WCAₐ analysis was carried out by carefully placing the tip of the fluid-filled syringe back into the formed water droplet and slowly injecting additional fluid. Fluid was continuously injected into the droplet while maintaining the contact line until the WCA no longer increased. The WCAₐ was defined to be the maximum WCA during injection. The instrument continually recorded as fluid was injected to determine the maximum angle. WCAᵣ was determined by gently pulling water back out of the droplet with the syringe. The droplet was again continually recorded to find the receding angle. Hysteresis was calculated as the difference between WCAₐ and WCAᵣ. All experiments were carried out in triplicate with two angles reported at each measurement (n=6).

In vitro testing design targets. It is estimated that an ESKD patient could ingest 50-g ZrP (at most) three times each day. The small intestine has an average volume of 1.5-L. The system was scaled down by 150× to give 330-mg ZrP in each 10-mL testing solution. Ions continuously diffuse between the small intestine, interstitial fluid, and blood. The ion diffusion was mimicked by continuously replacing the solution every IS minutes. Prior testing had shown that equilibrium concentrations of cations were reached in less than 15-minutes. The four 15-minute samples within every I-hour interval were combined to quantify total ion binding.

In vitro testing design targets were set to determine the clinical relevance of the coating (for example, ZrP-TP₂). Urea diffuses into the GI tract from the blood through the mucosa of the small intestine. 25% of urea formed in the body enters the small intestine of individuals with normal kidney function. If the blood urea-nitrogen (BUN) level of patients with ESKD was twice normal, total daily urea entering the small intestine of ESKD patients should double to 50% of daily production (120-mmol). Urea would be catalyzed in the small intestine to form 240-mmol NH₄⁺. Therefore, the minimum NH₄⁺ binding requirement for an effective oral sorbent was 1.6-mEq/g sorbent. Modified ZrP was tested to determine if the specified binding target was achieved within the expected small intestine residence timeframe (2 to 5-hours).

Nonspecific cation-exchangers have a high affinity for Ca²⁺. Ca²⁺ removal from the gut could lead to hypocalcemia. The upper-limit of Ca²⁺ removal by a sorbent should be no more than the limit used for guiding hemodialysis treatments. Approximately 2.4 (+/−0.2) mEq Ca²⁺ L⁻¹ of blood is ionized. Dialysate calcium baths commonly operate at 2.0 or 2.5 mEq Ca²⁺ L⁻¹ dialysate during hemodialysis treatment to avoid significantly altering the blood calcium level in the patient. 30-L of dialysate is processed every hour for 4-hours and with a 2-mEq L⁻¹ bath safely removes 48-mEq Ca²⁺ each treatment. Previous studies indicate the material size is desirably greater than 10-μm to avoid inspissation into the intestinal mucosa.

Determining Concentrations of NH4+ and Ca2+ for Simulated Small Intestine Solution Testing. ESKD patients with a high BUN level (such as 40-mg/dL) can be estimated to have a small intestine urea level of 20-mg/dl. (14-mM urea nitrogen). Expected levels of other cations present within the gut are given in Table 2 above.

All of the small cations compete for ZrP binding sites with NH₄⁺, though Ca²⁺ has the highest affinity for binding. A study was designed to replace the other competing ions by using a higher concentration Ca²⁺. The positive control was a solution of 4-mM Ca²⁺. The remaining solutions were made of the ion concentrations given in Table 2 with [Ca²⁺] of 4-mM, 8-mM, and 16-mM. No NH₄⁺ was used in the testing. Briefly, 10-mL of each solution was poured into a 20-mL glass test tubes in triplicate. 330-mg (±5-mg) of uncoated ZrP was poured into each test tube. The test tubes were capped and placed on a shaker plate at 240-rpm. The solutions were replaced every 15-minutes as described in subsection. [Ca²⁺] was recorded every hour for 5-hours. Results were determined via colorimetric analysis.

NH⁴⁺ and Ca²⁺ Binding Study Under Simulated Small Intestine Physiological Conditions. 0-mL of stock solution consisting of 14-mM NH₄⁺ and 12-mM Ca²⁺ (based on above experiments) was poured into nine 20-mL glass test tubes. Triplicates of 330-mg uncoated ZrP (positive control), ZrP-P₂, and ZrP-TP₂ were added to the 10-mL solutions. Each 330-mg sample was from its own batch of modified ZrP to assess batch-to-batch variation. The test tubes were capped and placed on a shaker plate at 240-rpm. Each test tube solution was renewed every 15-minutes according to the method in subsection 2.3. Samples were tested via colorimetric analysis.

Competing Ion Study. Studies were carried out to determine each FOTS sorbent material's capacity and selectivity for NH₄⁺ in the presence of a competing ion (Ca²⁺). Ca²⁺ is a divalent cation with a much higher affinity for ZrP than NH₄⁺, Mg²⁺, K⁺, or Na⁺. A previously published work defined a concentration of Ca²⁺ that had the same competition for binding on uncoated ZrP as occurred with a solution of Ca²⁺, Mg²⁺, K⁺, NH₄⁺, and Na⁺ at the expected concentrations in the small intestine.²⁴ Based on results of these studies, the solutions used in this work contained equimolar concentrations of Ca²⁺ and NH₄⁺ (35 mM each).

The materials assessed in the current study were ZrP-FOTS_{4%} and ZrP-FOTS_{7%}. FOTS coated sorbent materials were studied versus uncoated ZrP and ZrP-PDMS (ZrP-TP₂). Three batches of ZrP-PDMS were developed to compare to FOTS-based coatings. A testing solution comprised of 35-mM NH₄⁺, 35-mM Ca²⁺, and 20-mM sodium based (4-(2-hydroxyethyl)-1-piperazineethanesulfonic acid) (HEPES) buffer was made for the study (starting pH=8.3). Sodium-loaded HEPES was used within the experiments to buffer the alkaline pH during removal studies. HEPES is one of the ‘Good’ buffers commonly used within biological research due to its high level of water solubility, limited production of sodium, and pKa value within the biological range (6 to 8).

Briefly, 50-mg from each batch of material was placed in individual 24-mL test tubes (three test tubes for each material). 5-mL of testing solution was placed into each test tube and the tubes were capped and immediately placed horizontally on an orbital shaker plate with a 3-cm radial axis. The shaker plate was then set to 270-rpm to assure suspension of the dense ZrP particles in the solution. Each test tube was tested for [Ca²⁺] and [NH₄⁺ ] via colorimetric analysis. [NH₄⁺] data was collected at timepoints t=0-minutes, 20-minutes, 40 minutes, 1-hour, 2-hours, 3-hours, 6-hours, and 24-hours. [Ca²⁺] data was collected at t=1-hour, 2-hours, 3-hours, 6-hours, and 24-hours (assumed to be an average of gut transit time). All data points were collected in triplicate, each sample created in separate coating procedures. Selectivity was calculated as

$$\frac{mEq {NH}_{4}^{+} removed}{mEq {Ca}^{2 +} removed} .$$

The coated particles floated on the water due to their hydrophobic nature. A 10-μL pipette tip was lowered below the particles floating on the water surface during sampling to avoid removing sorbent particles in the sample. The uncoated ZIP particles sedimented quickly when stationary, creating a thin layer of clear fluid on top of the sorbent suspension. The pipette tip was placed into this layer of clear fluid to remove supernatant samples.

Acid Exposure Study. A solution of DI water was set to a pH value of 1.8 using HCl_{(aq)}. 20 mL of solution was poured into three 50-mL centrifuge tubes. 100 mg of ZrP-PDMS (ZrP-TP₂), ZrP-FOTS_{4%}, and ZrP-FOTS_{7%}, were added to all six 24-mL test tubes. The test tubes were capped and placed upright for three hours. The acid solution was then carefully removed from the coated sorbent material via a disposable pipette. The sorbent was then carefully washed with 20-mL aliquots of DI water, three times each. The stability of the coatings was quantified by repeating the analytical and in-vitro testing carried out on the materials before acid exposure.

Statistical Methods. All tests were carried out in triplicate. Three batches of each material were made and individually tested to determine batch-to-batch variation. Experimental values were presented as the means±standard deviation. Particle and indentation width distributions were found using 95% confidence interval (CI). Mean, standard deviation, coefficient of variation % (CoV %) and confidence intervals were all calculated via Microsoft Excel. P-values were calculated by using the standard t-test.

The foregoing description and accompanying drawings set forth a number of representative embodiments at the present time. Various modifications, additions and alternative designs will, of course, become apparent to those skilled in the art in light of the foregoing teachings without departing from the scope hereof, which is indicated by the following claims rather than by the foregoing description. All changes and variations that fall within the meaning and range of equivalency of the claims are to be embraced within their scope.

1. A composition, comprising: a solid particle comprising a sorbent material and a gas-permeable and hydrophobic coating formed over the solid particle, wherein the gas permeable and hydrophobic coating is formed via a coating technique in which one or more layers of one or more hydrophobic polymers is formed over a surface of the solid particle to encompass the solid particle while substantially preserving absorption capacity of the sorbent material.

2. The composition of claim 1 wherein the gas-permeable and hydrophobic coating is formed by spray coating a solution of the one or more hydrophobic polymers or by covalently attaching the one or more hydrophobic polymers to the surface of the solid particle via functional groups on the surface of the solid particle.

3. The composition of claim 1 wherein the sorbent material is an ion exchange material.

4. The composition of claim 3 further comprising a component to convert a gas passing through the gas-permeable and hydrophobic coating to an ion.

5. The composition of claim 3 wherein the sorbent material is a cation exchange material.

6. The composition of claim 3 wherein the one or more hydrophobic polymers comprise a polysiloxane, a fluoropolymer, an acrylate, a polyurethane acrylate, a polyacetylene, an addition-type polynorbornene, a polymer of intrinsic microporosity (PIM), a low-density polyethylene, or a polyimide.

7. The composition of claim 3 wherein the solid particle has an average diameter in the range of 10 nm to 10 mm.

8. The composition of claim 5 wherein the solid particle comprising the cation exchange material is a solid particle comprising zirconium phosphate, sodium zirconium cyclosilicate, or a resin-based cation exchange material, or a metal oxide.

9. The composition of claim 8 wherein the metal oxide is SiO₂ or TiO₂.

10. The composition of claim 3 wherein the one or more hydrophobic polymers are covalently attached to the surface of the solid particle comprising the sorbent material via a multifunctional compound which is reacted with one or more functional groups on the surface of the solid particle comprising the sorbent material and reacted with one or more functional groups on the one or more hydrophobic polymers.

11. The composition of claim 10 wherein the multifunctional compound has suitable functionality to increase the number of sites with which the hydrophobic polymer can covalently react after the multifunctional compound is reacted with the one or more functional group on the surface of solid particle.

12. The composition of claim 11 wherein at least one of the one or more hydrophobic polymers is a polysiloxane or a fluoropolymer and the multifunctional compound is tetraethyl orthosilicate or a compound including one or more trialkoxysilane groups.

13. The composition of claim 12 wherein the sorbent material is a cation exchange material and the solid particle comprising the cation exchange material comprises zirconium phosphate.

14. The composition of claim 5 wherein the cation exchange material is hydrogen loaded to convert a gas passing through the gas-permeable and hydrophobic coating to a cation.

15. The composition of claim 1 wherein the gas-permeable and hydrophobic coating is formed via spray coating of the surface of the solid particle.

16. A method of selectively removing a gas from an aqueous environment, comprising: contacting the aqueous environment with a plurality of the compositions, wherein each of the compositions comprises a solid particle comprising a sorbent material and a gas-permeable and hydrophobic coating formed over the solid particle, wherein the gas permeable and hydrophobic coating is formed via a coating technique in which one or more layers of one or more hydrophobic polymers is formed over a surface of the solid particle to encompass the solid particle while substantially preserving absorption capacity of the sorbent material.

17. The method of claim 16 wherein the sorbent material is an ion exchange material.

18. The method of claim 17 wherein each of the compositions further comprises a component to convert a gas passing through the gas-permeable and hydrophobic coating to an ion.

19. The method of claim 17 wherein the sorbent material is a cation exchange material.

20.-50. (canceled)

51. A composition, comprising: a solid substrate comprising a sorbent material and a gas-permeable and hydrophobic coating encompassing a surface of the solid substrate, wherein the gas-permeable and hydrophobic coating comprises one or more hydrophobic polymers and is formed using a coating technique that substantially preserves absorption capacity of the sorbent material.

52.-63. (canceled)
